(19) United States
(12) Patent Application Publication
(10) Pub. No.: US 2005/0158609 A1
(43) Pub. Date: Jul. 21, 2005

(54) Hydride-based fuel cell designed for the elimination of hydrogen formed therein

(76) Inventors: Gennadi Finkelshtain, Shoham (IL); Alexander Silberman, Haifa (IL); Mark Estrin, Kibbuz (IL); Igor Derzy, Petah Tikva (IL); Emilio Sanchez-Cortezon, Aix les Bains (FR); James H. Miners, Lutry (CH); Pascal Gouerec, Aix les Bains (FR)

Correspondence Address: GREENBLUM & BERNSTEIN, P.L.C., 1950 ROLAND CLARKE PLACE, RESTON, VA, 20191, US

(21) Appl. No.: 10/758,080

(22) Filed: Jan. 16, 2004

(51) Int. Cl. H01M 2/08; H01M 2/14; H01M 8/00

(52) U.S. Cl. 429/35; 429/36; 429/38; 429/39

(57) ABSTRACT

A fuel cell for use with a hydride-based fuel, which fuel cell is designed for being sealed in a liquid-tight manner when in operation. The fuel cell comprises means for eliminating hydrogen formed inside the fuel cell. This abstract is neither intended to define the invention disclosed in this specification nor intended to limit the scope of the invention in any way.

### BACKGROUND OF THE INVENTION

1. Field of the Invention

The present invention relates to a fuel cell for use with a hydride-based fuel which comprises means for the elimination of hydrogen gas formed therein.

2. Discussion of Background Information

Fuel cells are electrochemical power sources wherein electrocatalytic oxidation of a fuel at an anode and electrocatalytic reduction of an oxidant (often molecular oxygen) at a cathode take place simultaneously. Conventional fuels such as hydrogen and methanol pose several storage and transportation problems, in particular, for portable fuel cells (e.g., for use with portable electric and electronic devices such as laptops, cell phones, and the like). Borohydride (and other metal hydride) based fuels, on the other hand, are of particular interest for portable fuel cells due, in particular, to their very high specific energy capacity. Examples of corresponding fuels are disclosed, e.g., in U.S. 20010045364 A1, U.S. 20030207160 A1, U.S. 20030207157 A1, U.S. 20030099876 A1, and U.S. Pat. Nos. 6,554,877 B2 and 6,562,497 B2, the disclosures of which are expressly incorporated herein by reference in their entireties. However, hydride-based fuels also pose problems, for example, undesired gas (hydrogen) evolution, which apparently is of particular concern in fuel cells which are to operate in a sealed condition.

For example, the main oxidation reaction of the borohydride compound in a typical fuel comprising water, NaBH₄, methanol and NaOH at the anode of a fuel cell can be represented as follows:
BH₄⁻+8OH⁻=BO₂⁻+6H₂O+8 e⁻.
However, there also is a side reaction which leads to hydrogen evolution during the electrocatalytic oxidation:
BH₄⁻+4OH⁻=BO₂+2H₂O+2H₂+4 e⁻.
Moreover, usually there is also a spontaneous decomposition reaction of a borohydride compound:
BH₄⁻+2H₂O=BO₂⁻+4H₂.

The ratio of the desired oxidation reaction and the undesired side and decomposition reactions of the borohydride depends on many factors, inter alia, the current density, the temperature, the type of oxidation catalyst for the anode and the composition of the fuel.

Usually the fuel and electrolyte chambers of a fuel cell must be sealed hermetically in order to allow safe and comfortable use, transportation and storage of the fuel cell in any orientation thereof. The formation of hydrogen gas inside the fuel cell through, e.g., the above-described reactions, results in an increase in the pressure inside the fuel cell and thereby may cause substantial problems such as, e.g., destruction of the anode, changes in the electrical properties of the fuel cell and in some cases even an explosion of the fuel chamber. To avoid such problems and to ensure a safe operation, the fuel cell must be designed to permit the elimination of hydrogen gas even when the fuel cell is sealed in a liquid-tight manner.

It is widely known to use different kinds of hydrophobic membranes for gas-liquid separation processes. However, when these known membranes are used with a fuel cell which contains, e.g., a borohydride-based fuel, various technical problems are encountered. For example, during the operation of a borohydride-based fuel which comprises a borohydride suspension, an aerosol comprising solid and liquid particles as well as hydrogen is formed. This aerosol may damage the membrane both physically and by chemical attack. In particular, borohydride is a very strong reducing agent and, thus is capable of interacting and reacting even with materials which are generally considered to be inert (for example, organic silicon compounds), which may result in structure changes of the membrane material.

Further, the highly alkaline solutions usually employed in hydride-based fuel cells are capable of wetting even extemely hydrophobic materials (such as fluorinated polyolefins), thereby making it possible for solid particles to adhere to membrane surfaces and for membrane pores to become filled with fuel. All these effects adversely affect the gas permeability of a membrane.

It would be desirable to overcome the above-mentioned problems. Also, it would be desirable to have available a fuel cell from which gas can escape, irrespective of the orientation of the fuel cell (e.g., with the fuel cell in upright position, upside down, lying on its side, etc.) or can otherwise be eliminated.

### SUMMARY OF THE INVENTION

The present invention provides a fuel cell for use with a hydride-based fuel, which fuel cell is constructed and arranged to be sealed in a liquid-tight manner when in operation. The fuel cell comprises at least one opening for allowing hydrogen gas formed inside the fuel cell to escape therefrom. The opening is sealed by a membrane that is pervious to hydrogen gas and impervious to liquids and solids.

In one aspect, the membrane may comprise pores having diameters of from about 0.1 μm to about 5 μm and/or may have a thickness of from about 100 μm to about 300 μm.

In another aspect, the membrane may be a porous membrane which comprises a hydrophobic material. The hydrophobic material may comprise a fluorine containing polymer, for example, a fluorine containing polyolefin such as, e.g., polytetrafluoroethylene.

In another aspect, the membrane may comprise activated carbon.

In yet another aspect, the activated carbon may be dispersed in and/or bonded by the fluorine containing polymer.

In a still further aspect, the porous membrane may comprise a hydrogen-pervious coating on at least the side thereof which faces the interior of the fuel cell. The coating has a surface energy which is lower than the surface energy of the porous membrane. By way of non-limiting example, the coating may comprise a polymer with repeating units which comprise a fluorinated aliphatic group having at least about 5 fluorine atoms, e.g., a fluoroalkyl group having from about 4 to about 20 carbon atoms, preferably, a perfluoroalkyl group having from about 6 to about 10 carbon atoms such as e.g., a perfluorooctyl group. In one aspect, the polymer may comprise units derived from perfluorooctyl methacrylate.

In another aspect of the fuel cell of the present invention, the membrane may be a porous membrane which comprises an inorganic material. Non-limiting examples of the inorganic material include glass, e.g., borosilicate glass, ceramic, metal, e.g., stainless steel, alumina and zeolite. Further, the membrane may comprise pores having diameters of from about 0.1 μm to about 5 μm and/or may have a thickness of from about 20 μm to about 1 mm.

In another aspect of the porous membrane which comprises an inorganic material, the membrane may comprise a gas-pervious hydrophobic coating on at least that side thereof which faces the interior of the fuel cell. By way of non-limiting example, the coating may comprise fluorinated aliphatic groups having at least about 5 fluorine atoms such as, e.g., fluoroalkyl groups having from about 4 to about 20 carbon atoms, preferably, perfluoroalkyl groups having from about 6 to about 10 carbon atoms.

In one aspect, the fluorinated aliphatic groups may comprise a perfluorooctyl group.

In another aspect of the coating, the coating may be derived from one or more hydrolyzable silanes which have at least one fluorinated aliphatic group directly bonded to a silicon atom, the fluorinated aliphatic group comprising from about 6 to about 10 carbon atoms and at least about 5 fluorine atoms. By way of non-limiting example, the one or more hydrolyzable silanes may comprise at least one trialkoxyperfluoroalkylsilane such as, e.g., trimethoxyperfluorooctylsilane and/or triethoxyperfluorooctylsilane.

In a still further aspect of the fuel cell of the present invention, the membrane may be a non-porous membrane (e.g., a diffusion membrane). In one aspect, this membrane may comprise a silicone rubber and/or a PTFE-treated activated carbon. For example, the membrane may comprise from about 90% to about 50% by weight of activated carbon and from about 50% to about 10% by weight of PTFE.

In another aspect, the non-porous membrane may have a thickness of from about 20 μm to about 1000 μm.

The present invention also provides a membrane unit for a fuel cell which uses a hydride-based fuel. The unit is impervious to liquid and solid components of a hydride-based fuel and comprises at least one membrane which is pervious to gas. In one aspect, the membrane may be one of the porous and non-porous membranes which are discussed above with respect to the fuel cell of the present invention, including the various aspects thereof.

In another aspect, the unit may comprise at least one membrane which is impervious to liquid and pervious to hydrogen and, on at least one side of the at least one membrane, a protective element which protects the at least one membrane from a physical and/or a chemical attack by the fuel and its decomposition and reaction products.

In one aspect, the protective element may comprise a porous gas-pervious membrane which is more resistant to a physical and/or a chemical attack by the fuel and its decomposition and reaction products than the at least one membrane. By way of non-limiting example, this porous membrane may comprise activated carbon. It may also comprise a fluorine containing polymer, a preferred example whereof includes polytetrafluoroethylene. For example, the activated carbon may be dispersed in and/or bonded by the fluorine containing polymer.

In another aspect, the protective element may comprise a structure with sufficiently small openings to substantially prevent fuel-derived liquid and solid particles of high kinetic energy from physically attacking the at least one membrane. By way of non-limiting example, the openings may comprise holes having a diameter of not more than about 5 mm.

In another aspect, the protective element may comprise a structure which has skewed slots.

In yet another aspect, the protective element may comprise a foam element which comprises pores having diameters which are large enough to allow liquid to pass through the foam element. By way of non-limiting example, the foam element may comprise pores having diameters of from about 0.3 mm to about 5 mm. In another aspect, the foam element may have a thickness of from about 1 mm to about 5 mm. In a preferred embodiment, the foam element comprises polytetrafluoroethylene.

In a still further aspect, the protective element may comprises polyurethane, polyethylene, polypropylene, polyvinyl chloride and/or ABS copolymer.

In another aspect of the membrane unit of the present invention, the at least one membrane may comprise a reinforced membrane. By way of non-limiting example, the membrane may be reinforced by a mesh. In one aspect, the mesh may comprise a metallic material such as, e.g., nickel and/or stainless steel and/or the mesh may comprise an organic polymer such as, e.g., polytetrafluoroethylene, polypropylene, polyethylene and/or ABS (acrylonitrile-butadiene-styrene) copolymer.

The present invention also provides a fuel cell for use with a hydride-based fuel, which fuel cell comprises the membrane unit of the present invention, including the various aspects thereof as discussed above.

The present invention also provides a fuel cell for use with a hydride-based fuel, which fuel cell comprises at least one material which is capable of absorbing, adsorbing and/or undergoing a chemical reaction with molecular hydrogen.

In one aspect, the material may comprise a hydrogen sponge. By way of non-limiting example, the hydrogen sponge may comprise one or more of metallic platinum, palladium, titanium, nickel, aluminum and/or alloys thereof.

In another aspect, the material may comprise a molecular sieve. In yet another aspect, the material may comprise ceramics, zeolites, organic polymers and/or activated carbon.

In a still further aspect, the material may comprise a compound which is capable of being hydrogenated, preferably, in combination with a hydrogenation catalyst. For example, the compound may have an unsaturated bond. By way of non-limiting example, the unsaturated bond may comprises a carbon-carbon double and/or a carbon-carbon triple bond. Preferably, the material comprises at least one olefin having at least about 5 carbon atoms such as, e.g., a hexene.

In yet another aspect, the material may comprise a compound which is capable of oxidizing hydrogen, optionally in combination with an oxidation catalyst.

In one aspect, the compound may comprise an oxygen-containing compound, e.g., an oxygen-containing salt. By way of non-limiting example, the salt may comprise nitrogen and/or sulfur. Preferably, the salt comprises a nitrate.

In another aspect of the fuel cell, the material which is capable of absorbing, adsorbing and/or undergoing a chemical reaction with molecular hydrogen may be enclosed by an inert material which is liquid-impervious and pervious to hydrogen. The inert material may comprise a porous material. Preferably, the inert material forms a part of an element which is capable of being removed from the fuel cell.

In yet another aspect of the fuel cell, the material which is capable of absorbing, adsorbing and/or undergoing a chemical reaction with molecular hydrogen may be at least partially immobilized on one or more inner walls of the fuel cell.

The present invention further provides a fuel cell for use with a hydride-based fuel, which fuel cell comprises at least one material which is capable of at least one of absorbing, adsorbing and undergoing a chemical reaction with gaseous hydrogen formed therein, and further comprises at least one gas opening for allowing hydrogen gas formed inside the fuel cell to escape therefrom, which opening is sealed by a membrane that is pervious to hydrogen and impervious to liquids and solids. In one aspect, the at least one material and the membrane may comprise any of the materials and membranes discussed above, including the various aspects thereof.

The present invention also provides a fuel cell for use with a hydride-based fuel wherein at least a part of the fuel cell walls comprises a material which is pervious to hydrogen and impervious to liquids and solids.

The present invention further provides a fuel cell for use with a hydride-based fuel wherein at least two corners thereof, preferably all or substantially all corners, each comprise one or more openings which are sealed by a material which is pervious to hydrogen and impervious to liquids and solids. Non-limiting examples of such a material are materials with selective phase permeability such as, e.g., materials comprising pores, capillaries, micro-channels and the like.

The present invention also provides a fuel cell for use with a liquid fuel, which fuel cell comprises a fuel chamber and an electrolyte chamber and at least one of these chambers encloses a volume which is shaped approximately like a “C” or an “I”, i.e., with two approximately horizontal portions and one approximately vertical portion of the “C” or “I”.

In one aspect of this fuel cell, the two approximately horizontal portions together may enclose a volume which is not larger than about 10% and/or not smaller than about 1% of the total volume of the “C” or “I”.

In another aspect of the fuel cell, each of the horizontal portions of the “C” or the “I” may comprise at least one opening for allowing gas (e.g., hydrogen and/or air) inside the fuel cell to escape therefrom. The opening may be sealed by a membrane that is pervious to gas and impervious to liquids and solids, for example, one of the membranes discussed above, including the various aspects thereof.

As set forth above, the membranes for use in the present invention may be porous or non-porous and may comprise both organic and inorganic materials. In this regard, the term “non-porous membrane” as used in the present specification and in the appended claims is meant to include membranes which have “pores” in the nanometer range, e.g., pores formed on a molecular level. Usually, such “pores” are the result of bulky groups in molecules which constitute the membrane material, which give rise to “openings” or “channels” in the membrane structure through which non-polar and small molecules such as molecular hydrogen can still pass by a diffusion mechanism. Moreover, the term “porous” as used herein and in the appended claims is to be interpreted in a broad sense and includes, e.g., corresponding materials having pores, capillaries, micro-channels and the like. Accordingly, the term “pores” as used herein and in the present specification and the appended claim is meant to include pores, capillaries, micro-channels and the like.

Further, whenever the term “impervious” is used in the present specification and the appended claims, this term is meant to include embodiments of the respective material, element, structure, etc. which are substantially impervious, i.e., do not allow more than trace amounts of liquid/solid to pass therethrough.

The porous membranes for use in the present invention may comprise fine pores, e.g., pores having diameters which are not larger than about 30 μm, e.g., not larger than about 20 μm, not larger than about 10 μm, or not larger than about 5 μm. Usually their diameters are not smaller than about 0.05 μm, e.g., not smaller than about 0.1 μm, not smaller than about 0.5 μm, or not smaller than about 1 μm. The thickness of these membranes is not particularly critical, but will often be not smaller than about 50 μm, e.g., not smaller than about 100 μm, or not smaller than about 200 μm. The thickness will often be not larger than about 10 mm, e.g., not larger than about 5 mm, or not larger than about 2 mm.

The porous membranes for use in the present invention may comprise, or essentially consist of, one or more hydrophobic materials. Preferred hydrophobic materials are fluorine containing materials, in particular, fluorine containing organic polymers such as polymers which are derived from one or more fluorinated monomers. Preferred fluorinated monomers include fluorinated olefins, in particular, perfluorinated olefins such as, e.g., tetrafluoroethylene and hexafluoropropylene. A particulary preferred fluorine containing polyolefin for use in the present invention is polytetrafluoroethylene (PTFE, Teflon). Corresponding membranes are commercially available from various sources, for example, from Pall Corporation, Ann Arbor, Mich. (USA) under the trademark Emflon®. The Emflon® membranes are available in various thicknesses and with pore sizes in the range of from 0.1 to 3.0 μm.

The lowest surface energy of commercially available Teflon membranes currently is about 18-20 dynes/cm at room temperature. This surface energy may not always be entirely satisfactory for the membranes for use in the present invention. Accordingly, it may be desirable to coat the membrane with a material of a lower surface energy than that of the membrane on at least one side thereof, i.e., the side which is intended to come into contact with the fuel or any other liquid that is present inside the fuel cell, e.g., the electrolyte. Such a coating preferably provides a surface energy of not higher than about 12 dynes/cm, e.g., not higher than about 10 dynes/cm, not higher than about 8 dynes/cm, or even not higher than about 5 dynes/cm (at room temperature). Preferred coating materials include those which comprise (preferably substantially linear) fluorinated alkyl groups, preferably perfluorinated alkyl groups, having at least about 5, e.g., at least about 6, at least about 7, or at least about 8 carbon atoms. Non-limiting specific examples of such groups include perfluorohexyl, perfluorooctyl, perfluorodecyl and perfluordodecyl groups. Corresponding coating materials are commercially available from various sources. For example, for membranes which comprise or substantially consist of hydrophobic organic materials such as polytetrafluoroethylene and the like, suitable commercially available coating materials include those which are available from Cytonix Corporation, Beltsville, Md. (USA), under the trademark FluoroPel®. A preferred example of a coating material for use in the present invention is FluoroPel® PFC 601A, a solution of a polyperfluorooctyl methacrylate in a fluorinated solvent. Of course, other coating materials may be used as well as long as they are capable of lowering the surface energy of a membrane to the desired level.

Another material which may be beneficial for inclusion in a coating of a membrane for use in the present invention in general is a substance which catalyzes the formation of hydrogen gas by a reaction of the hydride compound (e.g., a borohydride). The evolution of hydrogen will create a minute flow of hydrogen gas on the membrane surface, thereby providing a self-cleaning effect. Apparently, the substance should be included in the coating only in trace amounts so as to not produce a substantial amount of otherwise undesirable hydrogen gas. Apparently, the formation of a large amount of hydrogen gas would significantly decrease the energy capacity of the fuel, which is disadvantageous. Substances which may catalyze the formation of hydrogen from a hydride compound are well known to those of skill in the art. Non-limiting examples thereof include salts of Ni, Fe, Co, Mg, Ca, etc.

Other examples of porous membranes for use in the present invention are those which comprise a porous carbon material, e.g., activated carbon, preferably in combination with a hydrophobic organic material as set forth above, e.g., a polytetrafluoroethylene. In a preferred embodiment, the porous membrane comprises these materials in a weight ratio carbon:PTFE of from about 90:10 to about 50:50 (e.g., 85:15, 70:30 etc.). Corresponding membranes are commercially available or can readily be prepared, for example, by milling (preferably, in a high speed mill and for at least 30 seconds) the components, e.g., the activated carbon powder (optionally, two or more different kinds of activated carbon having different pore sizes etc. may be used) and one or more PTFE powders and then forming the resultant paste or dough into a sheet of a desired thickness, for example, by extrusion, rolling, spraying, etc. Of course, such membranes, too, can be provided with a hydrophobic coating in order to lower their surface energy.

Membranes which comprise activated carbon in addition to one or more hydrophobic organic materials such as PTFE are sometimes not as effective gas-liquid separators as the membranes without carbon. However, in one embodiment of the present invention these two types of membranes may be combined in a single (e.g., integrated) structure, with the activated carbon-containing membrane substantially protecting the carbon-free membrane (e.g., a “pure” PTFE membrane) from direct contact with the fuel and its decomposition and reaction products (other than hydrogen). The thickness range for such a combination will often be from about 20 μm to about 1 mm. By way of non-limiting example, such a combination may have a total thickness of from about 200 μm to about 300 μm, with the carbon-free membrane having a thickness of, e.g., around 100 μm.

Further examples of porous membranes for use in the present invention include membranes which comprise, or essentially consist of, one or more inorganic materials such as, e.g., glass (e.g., borosilicate glass), ceramic, metals, including alloys thereof, e.g., stainless steel (e.g., 316 steel), alumina and zeolites (e.g., alumosilicates). Usually, these materials should be able to withstand concentrations of hydroxide ions or other bases of about 7 moles/L. If they are not stable enough in this respect (which may be the case, in particular, with alumina and some zeolites), the corresponding membrane may preferably be protected from direct contact with the fuel, e.g., by a protective coating and the like, as discussed below. Corresponding membranes will often comprise pores (capillaries) having diameters of from about 0.1 μm to about 5 μm and/or a thickness of from about 20 μm to about 1 mm. The pore volume will usually be at least about 60%, and will often not substantially exceed about 80%.

Like the porous membranes which comprise hydrophobic organic materials, porous membranes which comprise inorganic materials are preferably coated on at least that side thereof which is to come into contact with the liquids present inside the fuel cell. The coating may be substantially the same as that set forth above for the case of the membranes of hydrophobic organic materials, i.e., the coating provides a very low surface energy, usually due to fluorinated (aliphatic) groups contained therein. However, in order to obtain a satisfactory adhesion of the coating to a membrane surface comprising an inorganic material, it may be beneficial to use coating materials which can react or interact with, e.g., oxide and/or hydroxy groups on the surface of the inorganic membrane. Particularly preferred coating materials comprise hydrolyzable silanes which comprise at least one (per)fluorinated alkyl group (preferably having at least about 5 carbon atoms) which is directly bonded to the silicon atom. The remainder of the groups bonded to the silicon atom usually comprises hydrolyzable groups, preferably alkoxy groups (e.g. methoxy, ethoxy etc.), which react with the hydroxy groups on the surface of the membrane and thereby form a covalent bond between the silicon of the silane and the membrane surface. Suitable commercially available coating materials for use in the present invention include those which are available from Cytonix Corporation, Beltsville, Md., under the trademark FluoroSyl®. A preferred example of a coating material for use in the present invention is FluoroSyl® FSM660, a solution of a monofunctional perfluorooctyl trimethoxysilane in a fluorinated solvent.

Of course, other coating materials may be used as well, as long as they are capable of reducing the surface energy of the membrane to a desired (low) level, e.g., those set forth above for the hydrophobic organic membranes. Moreover, a fluoroalkylsilane material such as FluoroSyl® and the like may serve as a “primer” for inorganic membrane surfaces and improve the adhesion of other fluorinated materials which do not have the desired degree of adhesion to the inorganic material but may provide a lower surface energy than the fluoroalkylsilane material (e.g., an organic fluoropolymer such a the FluoroPel® series coating materials). In other words, it may be of advantage to first coat the inorganic membrane with a fluoroalkylsilane and then coat the thus coated surface with a fluoropolymer. As discussed above, the coating may also include a material which gives rise to a minute flow of hydrogen gas (due to decomposition of hydride material) on the surface of the membrane to thereby provide a self-cleaning effect.

Non-limiting examples of non-porous (diffusion) membranes for use in the present invention include membranes comprising, or consisting essentially of, e.g., a silicone rubber. Corresponding products are commercially available from various sources, for example, under the trade name NAGASEP from Nagayangi Co. Ltd., Tokyo, Japan. Another possible material for such non-porous membranes comprises a PTFE/activated carbon mixture. For example, such membranes may comprise from about 90% to about 50% by weight of activated carbon and from about 50% to about 10% by weight of PTFE. They may be prepared essentially in the same manner as described above for the corresponding porous membrane, by subsequently reducing the pore size thereof, e.g., by compressing the membrane to form a dense material with nm sized pores. Such a non-porous membrane will often have a thickness of from about 20 μm to about 1 mm, e.g., from about 200 μm to about 500 μm, although it may be significantly thinner or thicker as well.

The membrane unit of the present invention is impervious to liquid and solid components of a hydride-based fuel (including the decomposition and reaction products thereof) and comprises at least one membrane which is pervious to gas (or at least to hydrogen). In addition to the gas-pervious membrane, the unit may comprise one or more other components, for example, one or more further membranes, one or more protective elements for the membrane(s) and/or a reinforcement for the membrane(s). In this regard, it is to be understood that the various possible components of the membrane unit will not necessarily always be connected or otherwise linked together to form a single integrated structure. Rather, these components may be separate and may form a unit only after they have been installed in the fuel cell, and only in a sense that they are somehow associated with each other.

The membrane(s) of the membrane unit of the present invention may be (and preferably are) selected from those discussed above. The individual membranes may be porous or non-porous, organic or inorganic, coated or uncoated, etc. However, the single membrane or the combination of membranes together should ensure that the unit is gas (hydrogen)-pervious and impervious to solids and liquids.

In order to increase the service life of the at least one membrane of the membrane unit of the present invention it may be advantageous to shield at least that side of the membrane which is to face the interior of the fuel cell from a physical and/or a chemical attack by the fuel (including its decomposition and reaction products) or any other liquids present in the fuel cell (e.g., electrolyte).

An example of an protective element which may be used to shield the at least one membrane includes a porous gas-pervious membrane which is more resistant to a physical and/or a chemical attack by the fuel than the at least one membrane (but may not be as efficient a liquid-gas separator than the at least one membrane, e.g., may not be as liquid-impervious than the at least one membrane). By way of non-limiting example, this porous membrane may comprise activated carbon. It may also comprise a fluorine containing polymer, a preferred example whereof includes polytetrafluoroethylene. For example, the activated carbon may be dispersed in and/or bonded by the fluorine containing polymer. Non-limiting examples of such a membrane include the porous membranes of the type already discussed above, i.e., membranes which comprise porous (activated) carbon and one or more fluoropolymers. By appropriately selecting the types and relative amounts of the components, the thickness of the membrane, etc. the membrane can be tailor-made to have the desired properties in terms of resistance to physical and chemical attack by the fuel, permeability to gas, liquids and solids, etc. The porous membrane may be substantially separate from the at least one membrane or may form an integrated structure therewith (e.g., by placing the membranes on top of each other and applying pressure). Of course, any configuration between these two extremes is possible as well.

Another non-limiting example of a protective element for use in the membrane unit of the present invention includes a structure which comprises a material which is resistant to the hydride-based fuel (e.g., PTFE and other fluorinated materials, but also other fuel-resistant materials such as metals and alloys thereof) and has sufficiently small openings to substantially prevent fuel-derived liquid and solid particles of high kinetic energy (which may form inside the fuel cell in the course of the reactions taking place therein, as discussed above) from physically attacking the at least one membrane. An example of a corresponding structure comprises a perforated sheet (e.g., a PTFE sheet). By way of non-limiting example, the openings (perforations) may have a diameter of not more than about 5 mm, e.g., not more than about 2 mm, or not more than about 1 mm.

Alternatively or additionally, the structure may comprise other types of openings which, although possibly large enough to permit the passage of considerable amounts of liquid and solid particles per time unit, will decelerate the particles as they pass through these openings. Exemplary of such openings are skewed, irregular and the like openings (channels), in particular, skewed slots. Naturally, such structures will usually not be capable of shielding the at least one membrane of the membrane unit of the present invention from a chemical attack by the fuel (including its decomposition and reaction products) to any significant extent.

Yet another example of a protective element for use in the membrane unit of the present invention includes a foam element which comprises pores having diameters which are large enough to allow liquid to pass through the foam element. Similar to the structure which comprises skewed slots and the like, the pores of the foam will prevent liquid and solid (and/or aerosol) particles of high kinetic energy to pass straight through the foam element and without being (considerably) decelerated. By way of non-limiting example, the foam element may comprise pores having diameters of from about 0.3 mm, e.g., from about 0.5 mm, to about 5 mm, e.g., to about 4 mm. Also by way of non-limiting example, the foam element may have a thickness of from about 1 mm to about 5 mm. Naturally, the foam element, which may be rigid or flexible, should comprise a material which can withstand a chemical attack by the fuel for extended periods of time such as, e.g., polytetrafluoroethylene. Foam elements which are suitable for use in the present invention are commercially available from various sources, for example, from Foamex International Inc., Linwood, Pa. (USA).

A further exemplary way of shielding the at least one membrane of the membrane element of the present invention from at least a physical attack by solid/liquid fuel-derived particles is to place a shield (e.g. a sheet or the like) of a fuel-resistant material, which shield has dimensions which are at least about the same as or larger than the dimensions of the membrane in front of the membrane, but leaving room on at least one side of the shield to allow the gaseous, liquid and solid components inside the fuel cell to reach the membrane by bypassing the shield. Thereby, particles of high kinetic energy will be prevented from directly impacting on and thereby damaging the membrane. An exemplary embodiment of a corresponding shield is a Teflon sheet having a thickness of, for example, from about 0.5 mm to about 2 mm. Since the shield will be bypassed by the fuel components, it is not necessary for the shield to have any openings, although it is possible for the shield to additionally have openings, e.g., of the type discussed above.

Instead of leaving room on at least one side of the shield to enable the fuel components to bypass the shield, it is also possible according to the present invention to use a shield with dimensions which are larger in at least one direction than the dimensions of the at least one membrane, and to provide openings in the shield in areas thereof which are outside the area which corresponds to the membrane area. Thereby, particles of high kinetic energy will not be able to reach the membrane, if at all, before they have been decelerated. Apparently, the shield may also have openings in all or a part of the area which corresponds to the membrane area. However, in contrast to the openings in the non-membrane areas, the openings in the membrane area should have dimensions and/or configurations which by themselves (and not just by virtue of their location in the shield) do not allow particles of high kinetic energy to reach the membrane undeflected and/or undecelerated.

Yet another exemplary way of shielding the at least one membrane of the membrane element of the present invention from at least a physical attack by particles of the fuel components is to provide a basket structure of, e.g., of a mesh material, which encloses substantially the entire interior of the fuel cell or at least the part adjacent to the at least one membrane and extends, e.g., along the fuel cell walls. The openings in the basket should, of course, be sufficiently small to prevent particles of high kinetic energy to reach the at least one membrane without deflection/deceleration. For example, the mesh material may comprise a metallic material such as, e.g., a metal (such as, e.g., nickel) or an alloy (such as, e.g., stainless steel). Alternatively or additionally, the mesh may comprise an organic polymer such as, e.g., polytetrafluoroethylene, polypropylene, polyethylene and/or ABS copolymer.

It will be apparent to those of skill in the art that the membrane element of the present invention may comprise a combination of two or more protective elements such as, e.g., those set forth above.

Moreover, the protective element (as well as all other elements and structures for use in the present invention) may be coated, for example, with a material as described above for the membranes for use in the present invention (e.g., with hydrophobic, fluorine containing materials and/or a trace amount of a substance which catalyzes the formation of hydrogen, etc.).

The at least one membrane (and any other membrane) of the membrane unit of the present invention may comprise a reinforcement. Such a reinforcement should be capable of supporting the membrane and help to maintain the physical integrity thereof over extended periods of time. Such a reinforcement may be of particular advantage in the case of membranes which are very thin and/or made of material which is not very rigid. A non-limiting example of a suitable reinforcement includes a mesh. For example, the mesh may comprise a metallic material such as, e.g., a metal (such as, e.g., nickel) or an alloy (such as, e.g., stainless steel). Alternatively or additionally, the mesh may comprise an organic polymer such as, e.g., polytetrafluoroethylene, polypropylene, polyethylene and/or ABS copolymer. The mesh may be combined with the membrane in any suitable way, e,g., by placing the mesh on the membrane and applying pressure, gluing, etc. Of course, materials and structures other than those set forth above may be used as well for reinforcing the at least one membrane.

In addition to, or instead of, one or more membranes which allow hydrogen gas to escape from the fuel cell, the fuel cell of the present invention may comprise at least one material which is capable of absorbing, adsorbing and/or undergoing a chemical reaction with molecular hydrogen.

Examples of suitable hydrogen absorbents/adsorbents for use in the present invention comprise materials which are capable of absorbing/adsorbing hydrogen under the pressure and temperature conditions inside the fuel cell and, preferably, of releasing the hydrogen at a higher temperature and/or a lower pressure than that inside the fuel cell (whereby they may be regenerated and become reusable after they have been exhausted).

A non-limiting example of a suitable material which can absorb/adsorb hydrogen includes a so-called “hydrogen sponge”. Hydrogen sponges are well known to those of skill in the art. By way of non-limiting example, the hydrogen sponge may comprise one or more of metallic platinum, palladium, titanium, nickel, aluminum and alloys of these as well as other metals (e.g., a Pd—Cu alloy). Their capacity may be as high as 1 atom of hydrogen per 1 metal atom. Of course, care has to be taken that the hydrogen sponge material is sufficiently resistant to a chemical attack (e.g., dissolution) by a specific hydride-based fuel and its reaction and decomposition products. This may be of importance in cases where the hydrogen sponge comprises non-noble metals (such as, e.g., Al). Hydrogen sponges which comprise, e.g., Pd are preferred. Of course, it is possible to physically separate the hydrogen sponge from the liquids inside the fuel cell, for example, by providing an enclosing structure as discussed below, in which case the chemical resistance of the hydrogen sponge will not be an issue.

Further non-limiting examples of suitable hydrogen absorbents/adsorbents for use in the present invention include molecular sieve materials such as those which comprise ceramics, zeolites, organic polymers and/or activated carbon.

Non-limiting examples of materials which can undergo a chemical reaction with molecular hydrogen (hereafter sometimes referred to as “hydrogen-reactive materials”), optionally in the presence of a suitable catalyst, include agents or compounds which are capable of oxidizing molecular hydrogen and converting it into protons and related species, as well as compounds which are capable of incorporating hydrogen into their molecular structure, usually by covalent bonding. Non-limiting examples of the latter compounds include those which are capable of being hydrogenated such as, e.g. compounds which have one or more unsaturated bonds, i.e., double or triple bonds. These unsaturated bonds may exist between various elements, but will usually be bonds between carbon and carbon, carbon and nitrogen, nitrogen and nitrogen, carbon and oxygen, and carbon and sulfur, preferably between carbon and carbon.

Preferred hydrogenatable compounds for use in the present invention, mainly due to their price and availability, include aliphatic and cycloaliphatic hydrocarbons which have at least about 5, e.g., at least about 6 carbon atoms (but usually not more than about 30, e.g., not more than about 20 carbon atoms) and one or more (preferably not more than about two) unsaturated carbon-carbon bonds (preferably double bonds and, even more preferred, terminal double bonds). Non-limiting examples of such compounds include the pentenes, the hexenes (including cyclohexene), the heptenes, the octenes, the decenes, the dodecenes etc., as well as the corresponding dienes such as, e.g., the hexadienes, heptadienes, octadienes, etc. Of course, mixtures of different compounds and types of compounds, respectively, which are capable of being hydrogenated may be used as well.

Compounds which are capable of being hydrogenated usually are used in combination with a suitable hydrogenation catalyst. Non-limiting examples of such hydrogenation catalysts include the noble metals, in particular, Pd and Pt, but also non-noble metals such as Rh, Ru, Raney-Ni, etc. The metals are usually supported on finely divided porous materials, for example, titania, silica, alumina (hydrophilic), graphite and activated carbon (hydrophobic). Other examples of suitable hydrogenation catalysts will be apparent to those of skill in the art.

The hydrogenatable material and the hydrogenation catalyst will usually not be sufficiently resistant to a chemical attack by the components and decomposition and reaction products (other than hydrogen) of the hydride-based fuel (and, possibly, the electrolyte). Accordingly, these materials, usually dissolved and/or suspended in a suitable solvent such as, e.g., a saturated aliphatic hydrocarbon, will have to be physically separated from the components and reaction and decomposition products of the fuel, but in a manner which still permits sufficient access of hydrogen to these materials. Examples of suitable ways of accomplishing this will be discussed further below.

Species which are capable of oxidizing molecular hydrogen, optionally in the presence of a suitable hydrogenation catalyst, may be both organic and inorganic in nature and are well known to those of skill in the art. Non-limiting examples of suitable species comprise oxygen-containing compounds, e.g., inorganic and organic peroxides and oxygen-containing salts. The oxygen-containing salts will often comprise nitrogen and/or sulfur. Preferred examples of such salts include inorganic nitrates, e.g., those of alkali and alkaline earth metals such as Li, Na, K and Ca. Of course, mixtures of different oxidizing agents and different types of oxidizing agents, respectively, may be used as well.

Suitable oxidation catalysts for use in the present invention include the noble metals, in particular, Pd and Pt, but also non-noble metals such as Rh, Ru, etc. The metals are usually supported on finely divided porous materials of, e.g., titania, silica, alumina (hydrophilic), graphite and activated carbon (hydrophobic). Other examples of suitable oxidation catalysts will be apparent to those of skill in the art.

The oxidizing species and the oxidizing catalyst will usually not be sufficiently inert toward the components and reaction and decomposition products of the hydride-based fuel (and, possibly, the electrolyte). Accordingly, these materials, usually dissolved and/or suspended in a suitable solvent such as, e.g., water and/or aliphatic alcohols or an non-polar solvent such as an aliphatic hydrocarbon, will have to be physically separated from the components and decomposition products of the fuel, but in a manner which still permits sufficient access of hydrogen to these materials. Examples of suitable ways of accomplishing this will be discussed below.

Depending, inter alia, on the specific catalysts and the specific compound(s) to be used as hydrogen-reactive materials, hydrogen may be consumed at a rate of, e.g., about 10-100 ml H₂/mg metal*min (at a hydrogen pressure of 1 atm and at room temperature).

As indicated above, it will usually be desirable to physically separate the materials which are capable of absorbing, adsorbing and/or undergoing a chemical reaction with molecular hydrogen from the solid and liquid components and decomposition and reaction products of the hydride-based fuel while still allowing sufficient access of hydrogen to these materials. A preferred way of accomplishing this according to the present invention is to enclose these materials inside the fuel cell in one or more structures (e.g., containers) which are composed, at least in part, of a material which is liquid- (and solid-) impervious and pervious to hydrogen. The remainder of the structures, if any, should comprise materials which are impervious to both liquid and gaseous substances. Of course, the material or materials of which the enclosing structures are composed should be substantially inert toward and resistant to the hydride-based fuel and its decomposition and reaction products, the electrolyte, as well as the substances contained inside the structures, e.g., hydrogen-reactive materials and corresponding catalysts (as well as solvents, reaction products, etc.). At least the hydrogen-pervious parts of the structure(s) may often comprise materials similar to (or identical with) those discussed above as materials for the membranes, in particular, the porous membranes. To enhance the stability toward the chemicals inside and outside the structure(s), the inner and/or outer surfaces of the structure(s) may be coated with suitable materials which will not adversely affect the desired hydrogen-permeability to any significant extent (for example with the coating materials discussed above).

The enclosing structure(s) may be of any shape. Preferably, they are of a size which allows them to be easily removed from the fuel cell so that they can be replaced, if and when required, with one or more structures which contain fresh, unexhausted hydrogen-reactive materials (and corresponding catalysts). Of course, these structures may also be used for enclosing hydrogen absorbing/adsorbing materials such as, e.g., those discussed above.

An example of yet another way of keeping the hydrogen-reactive material (or the hydrogen absorbing/adsorbing material) from directly contacting the contents of the fuel cell (other than the hydrogen) is to impregnate a suitable matrix with the material. For example, particles of a catalyst may be immobilized in a gel-type matrix which may be impregnated with a hydrophobic hydrogen-reactive material. Hydrogen and the hydrogen-reactive material should be able to diffuse substantially throughout the entire gel to reach the catalyst particles. For example, the catalyst may comprise Pt, and the matrix may be polystyrene impregnated with benzene. Similarly, a part (e.g., up to about 50%) of the pores of granules of a porous hydrophobic catalyst may be impregnated with, for example, a hydrophobic hydrogen-reactive material. Accordingly, the density of the granules will be lower than the density of the liquids (fuel mixture, electrolyte, etc.) in the fuel cell. The granules will therefore float on the surface of the liquid(s) inside the fuel cell and will thereby be accessible to the generated hydrogen. A non-limiting example of such granules includes a Pd catalyst coated onto the surface of a highly porous carbon that has been made hydrophobic by partial fluorination.

Those of skill in the art will recognize that the different possible ways of eliminating hydrogen gas formed inside a hydride-based fuel cell, e.g., those discussed above, can be employed individually or simultaneously in any combination of two or more thereof.

For example, the hydride-based fuel cell according to the present invention may comprise one or more membranes which allow the hydrogen gas to escape from the fuel cell (if more than one membrane is present, the membranes may be the same or different, e.g., porous and non-porous, of different materials, different pore size, thickness, uncoated and/or coated with different materials, provided with different protective and/or reinforcement elements etc.) and, in combination therewith, one or more materials which are capable of at least one of absorbing, adsorbing and/or undergoing a chemical reaction with gaseous hydrogen. If two or more such materials are present, the materials may comprise, for example, at least one material that is capable of absorbing/adsorbing hydrogen and at least one material that is capable of undergoing a chemical reaction with hydrogen, or the materials may comprise at least one compound which is capable of being hydrogenated, and a compound which is capable of oxidizing molecular hydrogen, preferably, each in combination with a corresponding catalyst.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a cross section view of one non-limiting embodiment of a fuel cell. The internal parts of the fuel cell have been removed for the sake of clarity. This embodiment utilizes openings in the fuel cell wall, membranes are arranged in the openings and protective elements are arranged in an area of the openings;

FIG. 2 shows a cross section view of another non-limiting embodiment of a fuel cell. The internal parts of the fuel cell have been removed for the sake of clarity. This embodiment utilizes openings in the fuel cell wall, membranes are arranged in the openings and protective elements are arranged in an area of the openings;

FIG. 3 shows a cross section view of another non-limiting embodiment of a fuel cell. In this embodiment the fuel cell walls or at least a part of one of the fuel cell walls is made of membrane material;

FIG. 4a shows side views of various positions (rotated about a Y axis of FIG. 4c) that fuel (and/or electrolyte) within a fuel cell can assume when the fuel cell is moved about. Starting from the left side, the fuel (electrolyte) level can be seen moving from the horizontal to the vertical. The relationship between an anode and the fuel (electrolyte) level is shown in each of the positions;

FIG. 4b shows side views of various positions (rotated about a X axis of FIG. 4c) that fuel (and/or electrolyte) within a fuel cell can assume when the fuel cell is moved about. Starting from the left side, the fuel (electrolyte) level can be seen moving from the horizontal to the vertical. The relationship between an anode and the fuel (electrolyte) level is shown in each of the positions;

FIG. 4c shows in solid perspective form one non-limiting internal liquid volume configuration of a fuel cell, i.e., a C-shaped volume. The position of the anode relative to the liquid volume is also shown. The parts of the fuel cell which would define the volume shown is not illustrated for the sake of clarity;

FIG. 5a shows side views of various positions (rotated about a Y axis of FIG. 5c) that fuel (and/or electrolyte) within a fuel cell can assume when the fuel cell is moved about. Starting from the left side, the fuel (electrolyte) level can be seen moving from the horizontal to the vertical. The relationship between an anode and the fuel (electrolyte) level is shown in each of the positions;

FIG. 5b shows end views of various positions (rotated about an X axis of FIG. 5c) that fuel (and/or electrolyte) within a fuel cell can assume when the fuel cell is moved about. Starting from the left side, the fuel (electrolyte) level can be seen moving from the horizontal to the vertical. The relationship between an anode and the fuel (electrolyte) level is shown in each of the positions;

FIG. 5c shows in solid perspective form one non-limiting internal liquid volume configuration of a fuel cell, i.e., an I-shaped volume. The position of the anode relative to the liquid volume is also shown. The parts of the fuel cell which would define the volume shown is not illustrated for the sake of clarity;

FIGS. 6a-h show various views of a non-limiting fuel cell arrangement;

FIG. 7 shows another non-limiting fuel cell arrangement;

FIG. 8 shows a cut-away view of a portion of the fuel cell arrangement shown in FIG. 7;

FIG. 9 shows portions of the fuel cell shown in FIG. 7;

FIG. 10 shows an exploded view of the fuel chamber volume and the electrolyte chamber volume of the fuel cell shown in FIG. 7;

FIG. 11 shows another possible non-limiting embodiment of a fuel cell. This embodiment utilizes a protective element in the form of a solid shield;

FIG. 12 shows another possible non-limiting embodiment of a fuel cell. This embodiment utilizes a protective element in the form of an enclosure;

FIG. 13 shows another possible non-limiting embodiment of a fuel cell. This embodiment utilizes a protective element in the form of an enclosure and spacers;

FIG. 14 shows another possible non-limiting embodiment of a fuel cell. This embodiment utilizes a protective element in the form of an enclosure and mesh baskets;

FIG. 15 shows a partial cross-section view of a membrane with a coating;

FIG. 16 shows a partial cross-section view of a fuel cell wall with a coating;

FIG. 17 shows a cross-section view of another non-limiting embodiment of a fuel cell. This embodiment utilizes a membrane unit or bladder which conforms to the internal shape of the fuel cell;

FIG. 18 shows a partial front view of a membrane with a reinforcing mesh;

FIG. 19 shows a partial cross-section of a membrane unit of the type shown in FIG. 17 and an adjacent protective element which utilizes through apertures;

FIG. 20 shows a cross-section view of one non-limiting hydrogen absorbing/adsorbing device or material. The material includes a hydrogen absorbing/adsorbing material surrounded by a protective element with hydrogen-pervious apertures (pores);

FIG. 21 shows a cross-section view of one non-limiting hydrogen absorbing/adsorbing device or material. The material has an irregular shape with a relatively high surface area;

FIG. 22a shows a cross-section view one non-limiting device which can be placed in a fuel cell in order to provide absorption/absorption of and/or reaction with molecular hydrogen. The device utilizes an absorbing/adsorbing and/or hydrogen-reactive material surrounded by a liquid-impervious material;

FIG. 22b shows a cross-section view of another non-limiting device which can be placed in a fuel cell in order to provide absorption/absorption of and/or reaction with molecular hydrogen. The device utilizes an absorbing/adsorbing and/or hydrogen-reactive material coated and/or covered with a liquid-impervious material;

FIG. 23 shows a cross-section view of another non-limiting fuel cell. The fuel cell utilizes a removable device for providing absorption/absorption of and/or reaction with molecular hydrogen. The device is immobilized within the fuel cell with retaining members;

FIG. 24 shows a cross-section view of another non-limiting fuel cell. The fuel cell utilizes a device for providing absorption/absorption of and/or reaction with molecular hydrogen. The device is immobilized within the fuel cell by attachment to a surface; and

FIG. 25 shows a cross-section view of another non-limiting fuel cell. This embodiment incorporates a membrane material in the wall of the fuel cell.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description making apparent to those skilled in the art how the several forms of the present invention may be embodied in practice.

### EXAMPLE 1

Procedure for Coating a PTFE Membrane with a Hydrophobic Material

The membrane to be coated is first cleaned by dipping it into ethanol and thereafter into acetone, each for a few seconds. The membrane is then left to dry in air for at least about 20 minutes, whereafter it is transferred into a vacuum oven and dried for about 30 minutes at about 70° C. The thus cleaned and dried membrane is dipped into a solution of the coating material (e.g., FluoroPel® PFC 601A, a 1% fluoropolymer solution in 3M HFE 7100 fluorosolvent (b.p. 61° C.)) for about 10-15 seconds. The thus coated membrane is left to dry in air for about 30 minutes and then vacuum-dried at 90° C. for about 2 hours.

### EXAMPLE 2

Procedure for Coating a Membrane with an Oxide Surface with a Hydrophobic Material

The membrane with an oxide surface (e.g., comprising glass, metal etc.) is treated in the same manner as described in Example 1, but using FluoroSyl® FSM660 (a fluoroalkyl monosilane in a high boiling fluorinated surface providing low surface energy to oxide surfaces and a good adhesion for fluoropolymers) instead of FluoroPel® PFC 601A.

### EXAMPLE 3

Membranes of Activated Carbon and PTFE

| | Activated | | |
|---|---|---|---|
| Membrane | Carbon | PTFE | Thickness |
| No. | (wt.-%) | (wt.-%) | (μm) |
| 1 | 85 | 15 | 450 |
| 2 | 85 | 15 | 220 |
| 3 | 70 | 30 | 400 |
| 4 | 70 | 30 | 270 |
| 5 | 50 | 50 | 400 |
| 6 | 50 | 50 | 200 |

The above membranes are made by subjecting powders of activated carbon (Pica Ltd., USA) and PTFE to high-speed milling and rolling the resultant dough or paste to the desired thickness. By compressing the membranes, a dense material with nm sized pores may be produced.

Membranes similar to the above membranes but having a thickness of 200 μm and 100 μm, respectively, are included in a bi-layer configuration by combining them with a PTFE membrane (100% PTFE, thickness 100 μm), to form bi-layer membranes having total thicknesses of 300 μm and 200 μm, respectively.

By way of one non-limiting example, FIG. 1 shows a fuel cell FC for use with a hydride-based fuel. The fuel cell FC is designed for being sealed in a liquid-tight manner when in operation. The fuel cell FC may include one or more openings, e.g., two openings O arranged in the wall W of the fuel cell FC. These openings O allow hydrogen gas formed inside the fuel cell FC to escape therefrom. Each opening O is sealed by a membrane M that is pervious to hydrogen gas and impervious to liquids and solids. The size and shape of the fuel cell FC can, of course, vary—as can the size, shape, position and number of the openings O.

The membrane M can be of any type as long as it is pervious to hydrogen gas and impervious to liquids and solids, for example of the type described herein. The fuel cell FC also includes a shield or protective element PE. The protective shield PE prevents mechanical destruction of the membrane M by, e.g., reducing the kinetic energy of fuel-derived solid and/or liquid particles before they contact the membrane M. This may significantly increase the membrane M service life.

The protective element PE may alternatively have the form of a foam member whose pores may have a diameter of, e.g., between about 0.05 mm and about 5 mm. Such pore sizes allow to reduce the kinetic energy of fuel-derived particles and protect to at least some extent the membrane M from mechanical damage.

The protective element PE may also alternatively have the form of a shield with slots, e.g., skewed slots. The slots are sized to reduce the kinetic energy of fuel-derived particles, thereby protecting to at least some extent the membrane M from mechanical damage.

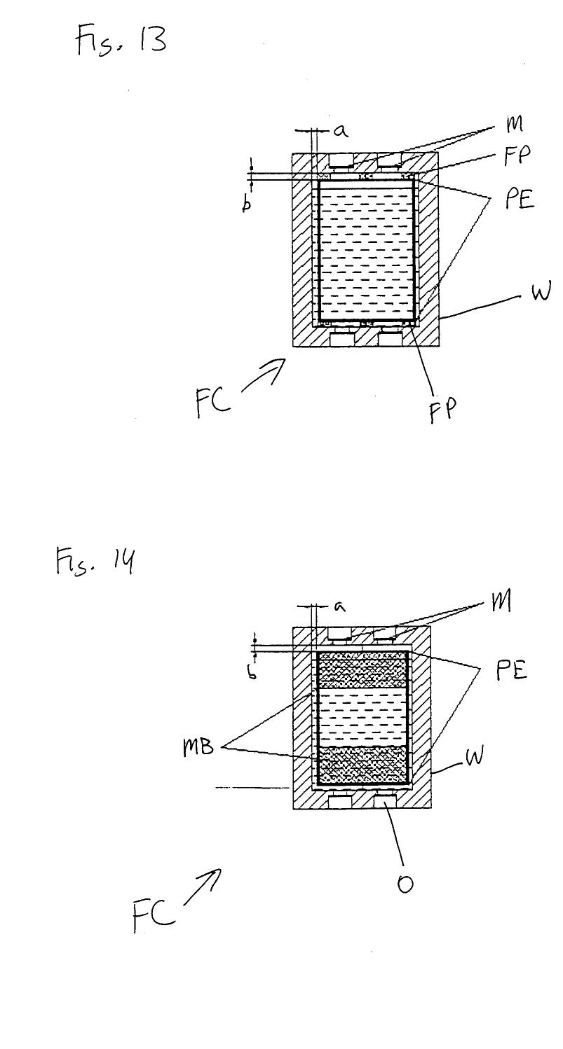

The membrane M may also include a coating C (see FIG. 15), for example, of the type described herein such as, e.g., a hydrogen-pervious coating arranged on at least one side thereof. Preferably, the coating C faces an interior of the fuel cell FC.

The membrane M may also be a porous membrane which comprises an inorganic material. Non-limiting examples of the inorganic material include glass, e.g., borosilicate glass, ceramic, metal, e.g., stainless steel, alumina and zeolite. Further, the membrane may comprise pores having diameters of from about 0.1 μm to about 5 μm and/or may have a thickness “th” of from about 20 μm to about 1 mm (see FIG. 15).

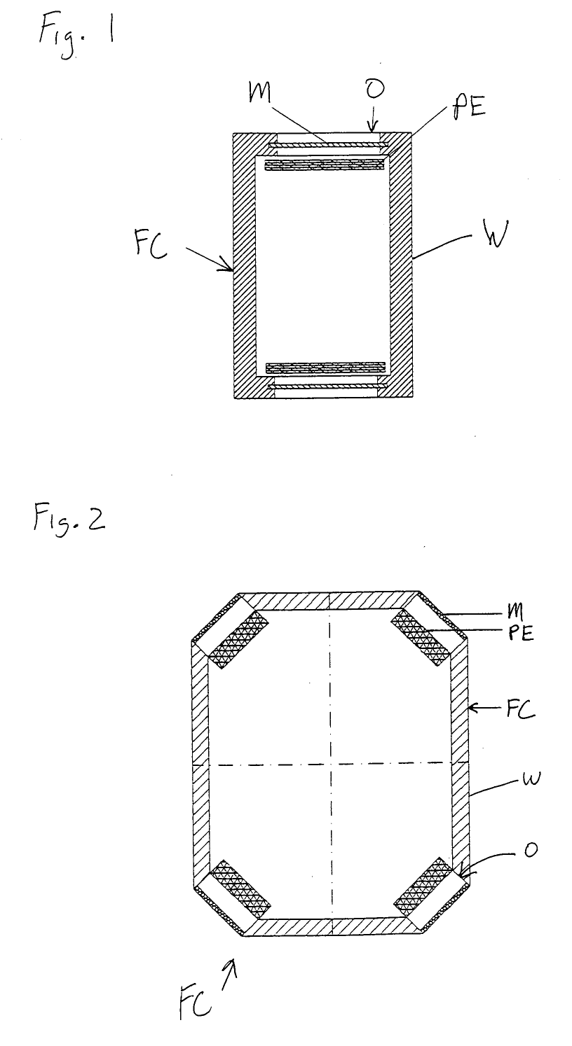

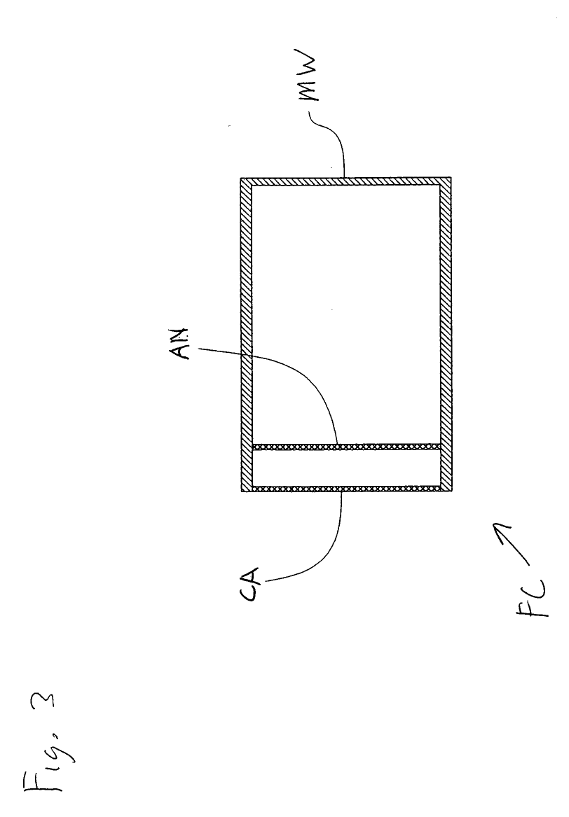

By way of another non-limiting example, FIG. 2 shows a fuel cell FC for use with a hydride-based fuel. The fuel cell FC is designed for being sealed in a liquid-tight manner when in operation. The fuel cell FC can include one or more openings, e.g., four openings O, arranged in the corners of the fuel cell FC. These openings O allow hydrogen gas inside the fuel cell FC to escape therefrom. Each opening O is sealed by a membrane M that is pervious to hydrogen gas and impervious to liquids and solids. The size and shape of the fuel cell FC can, of course, vary—as can the size, shape, and number of the openings O. The membrane M can be of any type as long as it is pervious to hydrogen gas and impervious to liquids and solids, for example, of the type described herein. Moreover, the protective element PE can otherwise have the same features as was described above with regard to FIG. 1. Additionally, as is possible with the embodiment shown in FIG. 1, the embodiment shown in FIG. 2 can also be practiced without utilizing protective elements PE arranged in an area of the openings O.

By way of another non-limiting example, FIG. 3 shows a fuel cell FC for use with a hydride-based fuel. The fuel cell FC is designed for being sealed in a liquid-tight manner when in operation. The fuel cell FC includes an anode AN, a cathode CA, and one or more walls which are formed of membrane material. The membrane walls MW allow hydrogen gas formed inside the fuel cell FC to escape therefrom. The membrane walls MW are pervious to hydrogen gas and impervious to liquids and solids. The size and shape of the fuel cell FC can, of course, vary—as can the size, shape and number of the membrane walls MW. The invention contemplates that at least one portion of the membrane walls MW can utilize membrane materials of the type described herein.

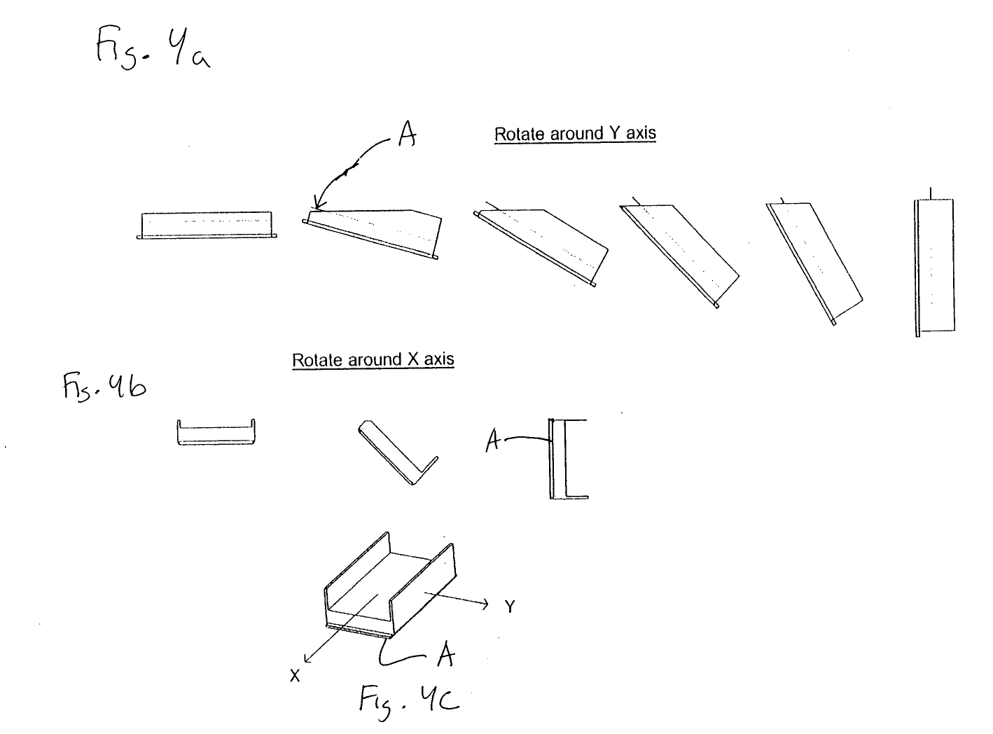

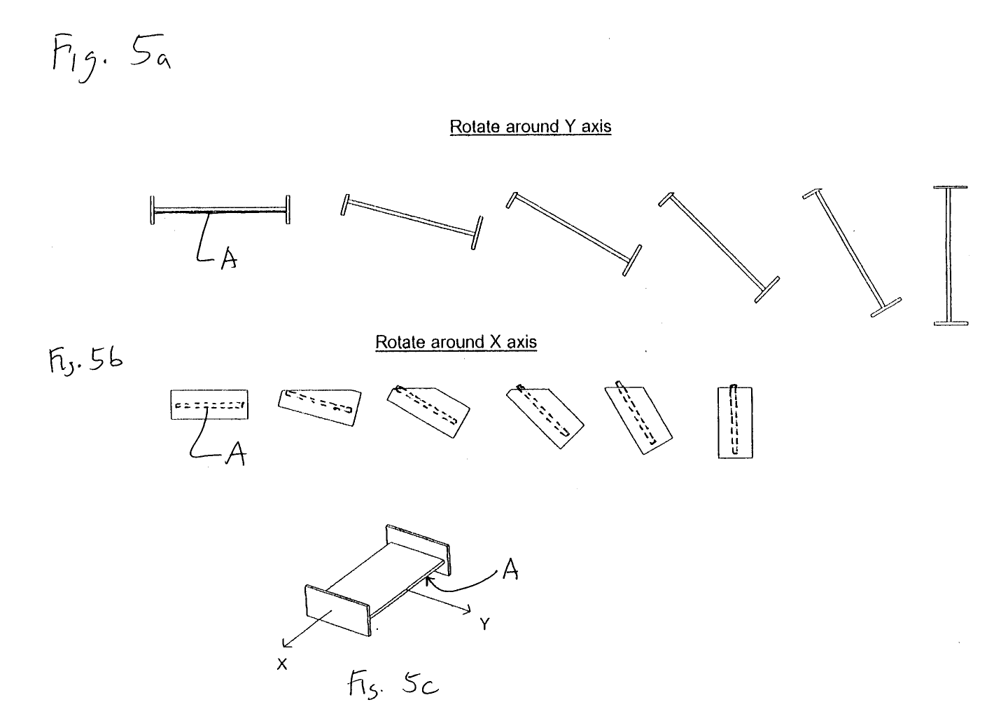

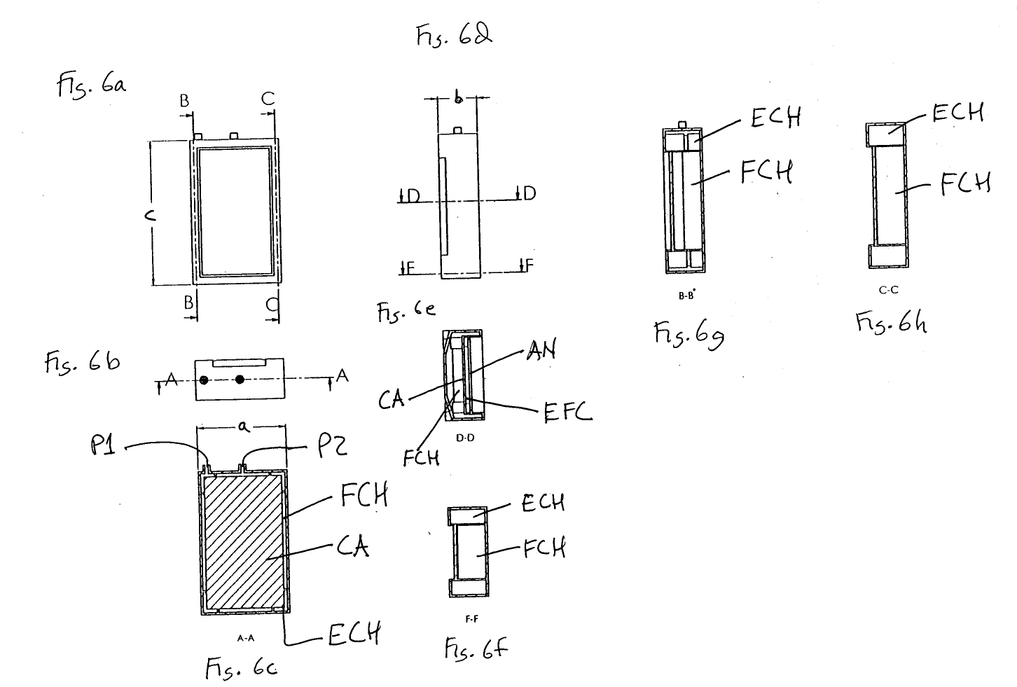

The arrangement shown in FIGS. 4 and 5 take advantage of the fact that gas such as hydrogen and/or air inside the fuel cell will usually collect in certain parts/areas of the fuel cell depending on the orientation of the fuel cell. Because gas has a natural tendency to accumulate in these areas, this can be the best place to locate a gas elimination device or to provide for gas elimination. The fuel cell design shown in FIGS. 4 a-c thus provides for extra volume for the gas, and takes account of the following relationship: if the fuel or electrolyte volume is X, then the fuel or electrolyte chamber volume should preferably be designed according to the formula (1+y)*X, with “y” varying between about 0.01 to about 0.1. Such parts/areas may include, e.g., corners of the fuel cell.

In order to ensure that the fuel cell has this extra volume, the fuel and/or the electrolyte chamber may have the shape of an “I” (see FIGS. 5a-c) or “C” (see FIGS. 4a-c). When, for example, the electrolyte chamber is filled with electrolyte, this should be done in a manner so that the volume between the electrodes is totally filled with electrolyte. The additional volume of the chamber created by the upper and lower portions of the C-shaped or I-shaped chamber or volume is filled with gas (e.g., air and/or hydrogen). In the same way, the fuel chamber can be totally filled in between a chamber wall and the anode, and the extra volume is filled with gas (e.g., air and/or hydrogen). During fuel cell operation, hydrogen that is being generated, accumulates in the corners of the upper and lower portions of the C- or I-shaped chamber. The hydrogen (which is lighter than air) moves toward the highest point which preferably contains an opening sealed by the membrane M. If the fuel cell is then rotated, some fluid volume fills the lower additional portion and gas is driven up to the upper additional portion. In this way, gas elimination can be a continuous process, i.e., can occur at any and all times and in any and all orientations of the fuel cell. The fuel cell is preferably designed to ensure that at least about 97% of the electrode area in direct contact with the liquid (fuel or electrolyte) even in a worst case orientation.

As noted above, the invention contemplates a fuel cell which may or may not utilize membranes and which can accommodate the hydrogen in a manner which does not significantly affect the fuel cell energy output. FIGS. 4a-c, for example, show one possible internal fuel cell volume configuration. The parts of the fuel cell FC which would enclose and/or define the volume illustrated are not shown for the sake of clarity. These figures show, by way of example, a C-shaped volume for the liquid fuel (and/or electrolyte) of the fuel cell. Thus, FIG. 4a shows side views of various positions (rotated about a Y axis of FIG. 4c) that fuel (electrolyte) within a fuel cell can assume when the fuel cell is moved about. Starting from the left side, the fuel level can be seen moving from the horizontal to the vertical. The relationship between an anode A and the fuel (electrolyte) level is shown in each of the positions.

FIG. 4b shows end views of various positions (rotated about an X axis of FIG. 4c) that fuel (electrolyte) within a fuel cell can assume when the fuel cell is moved about. Starting from the left side, the fuel (electrolyte) level can be seen moving from the horizontal to the vertical. The relationship between the anode A and the fuel (electrolyte) level is shown in each of the positions. A fuel cell FC which utilizes the internal volume shown in FIGS. 4a-c relative to the position of the anode A ensures good performance in any orientation. Since it is important that the electrodes, i.e., the cathode and anode, be contacted by the electrolyte and fuel at all times and positions of operation, one can design fuel and electrolyte chambers such that, e.g., at least about 95% of the surface areas of the electrodes are contacted by these fluids at all times. Thus, for example, FIG. 4a shows that in each of the positions, at least 95% of the anode A is immersed within the fuel (electrolyte). FIG. 4b shows that in each of the positions, at least 95% of the anode A is immersed within the fuel. Moreover, since excess hydrogen can displace enough liquid to reduce this contact, it can be advantageous to design these volume chambers in a way which prevents a reduction in fuel cell performance.

FIGS. 4a-c show one non-limiting way in which one can design the volume of the fuel and/or the electrolyte. The position of the anode A relative to the liquid level is shown in each of the various positions. Although FIGS. 4a-c show the volume arrangement for an anode A, the invention contemplates such an arrangement for the cathode as well.

FIG. 5a shows side views of various positions (rotated about a Y axis of FIG. 5c) that fuel (electrolyte) within a fuel cell can assume when the fuel cell is moved about. Starting from the left side, the fuel (electrolyte) level can be seen moving from the horizontal to the vertical. The relationship between an anode and the fuel (electrolyte) level is shown in each of the positions. FIG. 5b shows end views of various positions (rotated about an X axis of FIG. 5c) that fuel (electrolyte) within a fuel cell can assume when the fuel cell is moved about. Starting from the left side, the fuel (electrolyte) level can be seen moving from the horizontal to the vertical. The relationship between an anode and the fuel (electrolyte) level is shown in each of the positions. FIG. 5c shows in solid perspective form one non-limiting internal liquid volume configuration of a fuel cell, i.e., an I-shaped volume. The position of the anode relative to the liquid volume is also shown. The parts of the fuel cell which would define the volume shown is not illustrated for the sake of clarity. This I-shaped arrangement may otherwise function in the same general way as was described with regard to FIGS. 4a-c.

FIGS. 6a-h show various views of one non-limiting fuel cell arrangement which utilizes a C-shaped volume. The fuel cell may have the following dimensions: “a”=approximately 79 mm, “b”=approximately 35 mm, and “c”=approximately 127 mm. As can be seen in these figures, the fuel cell includes a first port P1 which can be connected via a tube to a valve and a second port P2 which can be connected via another tube to the valve. Port P1 is coupled (i.e., provides fluid communication with) to the electrolyte chamber ECH while port P2 is coupled to (i.e., provides fluid communication with) the fuel chamber FCH. The fuel cell also includes an anode AN and a cathode CA.

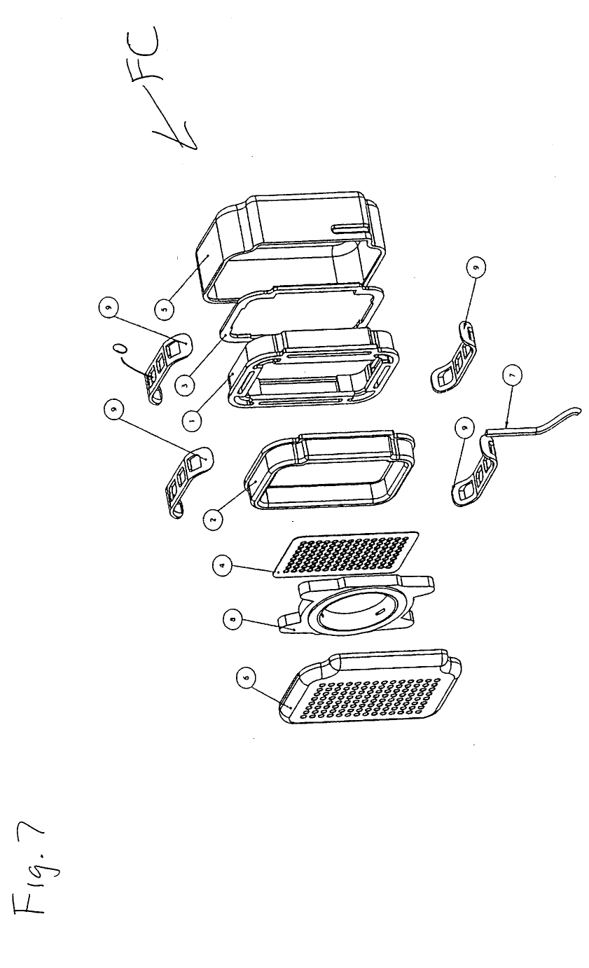

FIGS. 7-10 show various views of a non-limiting fuel cell arrangement which incorporates gas evacuation devices and specifically shaped fuel and electrolyte chambers. The fuel cell FC has a front cover 6, a valve 8, a protective net 4 for protecting the cathode, a second fuel cell body 2, a first fuel cell body 1, a back cover 3 and an external casing 5. The elongated channels in body 1 form extra volume chambers for the fuel whereas the short curved corner channels form extra volume chambers for the electrolyte (see FIG. 10). The body 2 has a generally similar channel configuration as body 1 (not shown). The fuel cell FC also includes gas elimination devices (GEDs) in the form of membrane frames 9. The membrane frames 9 can be attached to the bodies 1, 2 and include openings O which accommodate membranes M of the type described above. An electric wire 7 is coupled to the fuel cell FC.

FIG. 8 shows a cross-section of a portion of the fuel cell of FIG. 7. The figure illustrates the cathode CA, anode AN, a chamber EV which provides extra volume for gas, and a C-shaped fuel chamber CFC. The figure also shows grooves G which allow the gas to exit from the fuel cell bodies.

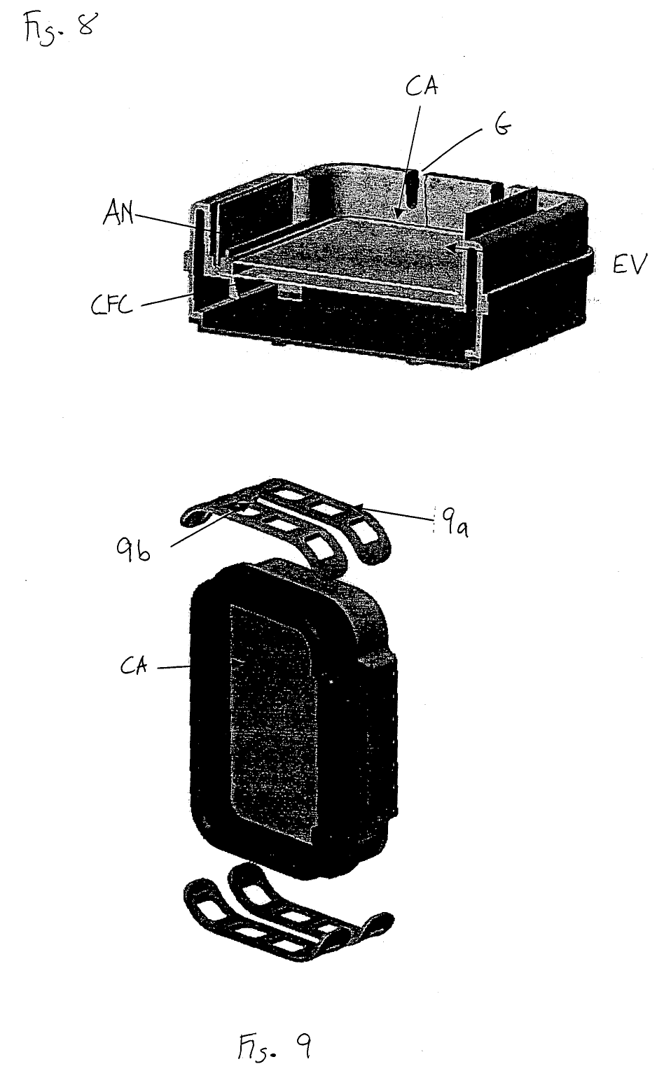

FIG. 9 shows a side view of a portion of the fuel cell of FIG. 7. The figure illustrates the cathode CA, the membrane frames 9a for the electrolyte chamber, and the membrane frames 9b for the fuel chamber.

FIG. 10 shows perspective views of the fuel and electrolyte chambers which are defined by the walls of the fuel cell shown in FIG. 7. The figure illustrates a C-shaped fuel chamber volume FCV and an I-shaped electrolyte chamber volume ECV. Fuel chamber inner volume FCV (illustrated as solid body) has four tower portions TP which form extra volume chambers. The electrolyte chamber inner volume ECV (also illustrated as solid body) utilizes projecting corner structures PCS which form extra volume chambers.

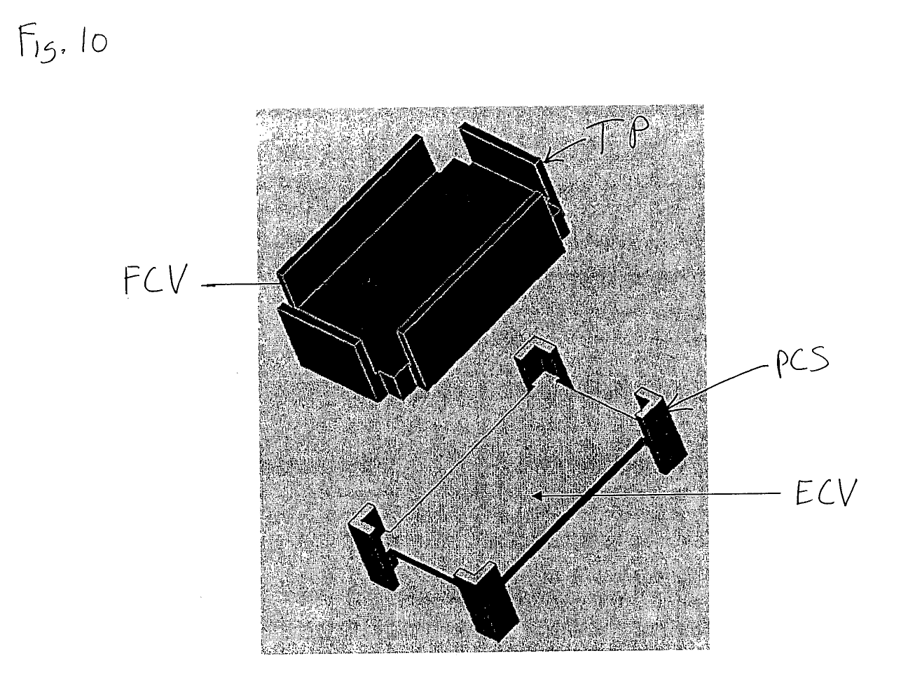

By way of another non-limiting example, FIG. 11 shows a fuel cell FC for use with a hydride-based fuel. The fuel cell FC is designed for being sealed in a liquid-tight manner when in operation. The fuel cell FC includes liquid L and one or more openings, e.g., four openings O arranged in the walls W of the fuel cell FC. These openings O allow hydrogen gas formed inside the fuel cell FC to escape therefrom. Each opening O is sealed by a membrane M that is pervious to hydrogen gas and impervious to liquids and solids. The membranes M are arranged adjacent a bottom shoulder of the openings O. The size and shape of the fuel cell FC can, of course, vary—as can the size, shape, position and number of the openings O. The membranes M can, of course, be of any type as long as they are pervious to hydrogen gas and impervious to liquids and solids, for example, of the type described herein. The fuel cell FC also includes protective elements PE. In the embodiment shown in FIG. 11, the protective elements PE can have the form of a teflonized sheet, e.g., of approximately 1 mm thick. Preferably, the protective elements PE have the form of a solid shield. The protective elements PE can be spaced from walls W such that, e.g., dimension “a” is approximately 2 mm and dimension “b” is approximately 3 mm.

By way of another non-limiting example, FIG. 12 shows a fuel cell FC for use with a hydride-based fuel. The fuel cell FC is designed for being sealed in a liquid-tight manner when in operation. The fuel cell FC includes liquid L and one or more openings, e.g., four openings O arranged in the walls W of the fuel cell FC. These openings O allow hydrogen gas formed inside the fuel cell FC to escape therefrom. Each opening O is sealed by a membrane M that is pervious to hydrogen gas and impervious to liquids and solids. The membranes M are arranged adjacent a bottom shoulder of the openings O. The size and shape of the fuel cell FC can, of course, vary—as can the size, shape, position and number of the openings O. The membranes M can, of course, be of any type as long as they are pervious to hydrogen gas and impervious to liquids and solids, for example, of the type described herein. The fuel cell FC also includes a protective element PE. In the embodiment shown in FIG. 12, the protective element PE has the form of an enclosure made of a thin (Teflon) sheet material, e.g., approximately 1 mm thick. The protective element PE includes walls (which may form a generally rigid frame structure) which are arranged generally parallel to the fuel cell walls W. The sheet material forming the protective element also includes through openings for improving gas flow. The openings are arranged in all areas of the sheet material except for areas which are directly adjacent the openings O and/or membranes M. The protective element PE can be spaced from walls W such that, e.g., dimension “a” is approximately 2 mm and dimension “b” is approximately 3 mm.

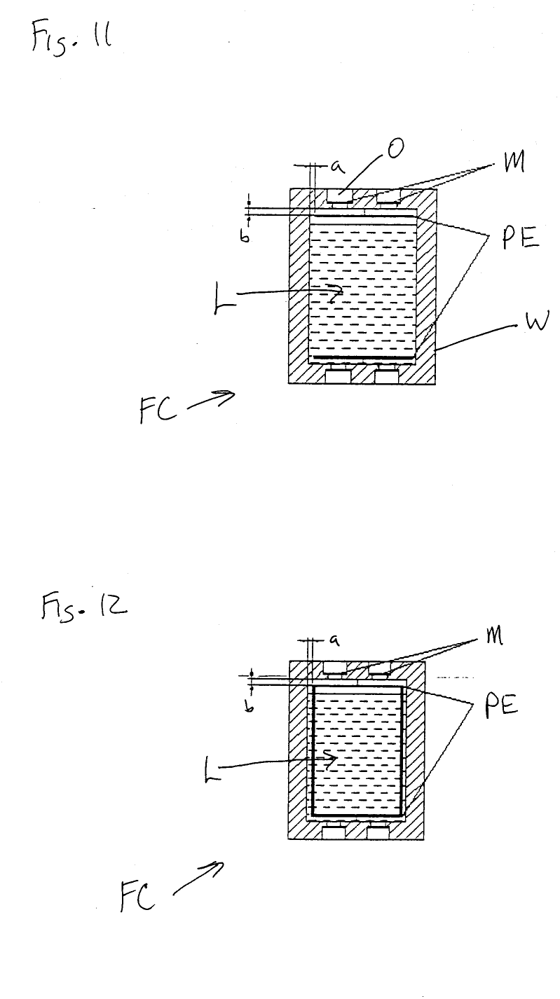

By way of another non-limiting example, FIG. 13 shows a fuel cell FC for use with a hydride-based fuel. The fuel cell FC is designed for being sealed in a liquid-tight manner when in operation. The fuel cell FC includes liquid L and one or more openings, e.g., four openings O arranged in the walls W of the fuel cell FC. These openings O allow hydrogen gas formed inside the fuel cell FC to escape therefrom. Each opening O is sealed by a membrane M that is pervious to hydrogen gas and impervious to liquids and solids. The membranes M are arranged adjacent a bottom shoulder of the openings O. The size and shape of the fuel cell FC can, of course, vary—as can the size, shape, position and number of the openings O. The membranes M can, of course, be of any type as long as they are pervious to hydrogen gas and impervious to liquids and solids, for example, of the type described herein. The fuel cell FC also includes a protective element PE. In the embodiment shown in FIG. 13, the protective element PE has the form of an enclosure made of a thin (Teflon) sheet material, e.g., approximately 1 mm thick. The protective element PE includes walls (which may have the form of a generally rigid frame structure) which are arranged generally parallel to the fuel cell walls W. The sheet material forming the protective element PE also includes through openings for improving gas flow. The openings O are arranged in all areas of the sheet material except for areas which are directly adjacent the openings O and/or membranes M. The protective element PE can be spaced from walls W with foam pieces FP such that, e.g., dimension “a” is approximately 2 mm and dimension “b” is approximately 3 mm. The foam pieces FP help to support the protective element PE frame structure and provide additional protection for the membranes M. They can also be arranged such that, e.g., the fuel and/or gas must pass through both the protective element PE (i.e., through the openings) and through the foam pieces FP before they contact the membranes M.

By way of another non-limiting example, FIG. 14 shows a fuel cell FC for use with a hydride-based fuel. The fuel cell FC is designed for being sealed in a liquid-tight manner when in operation. The fuel cell FC includes liquid L and one or more openings, e.g., four openings O arranged in the walls W of the fuel cell FC. These openings O allow hydrogen gas formed inside the fuel cell FC to escape therefrom. Each opening O is sealed by a membrane M that is pervious to hydrogen gas and impervious to liquids and solids. The membranes M are arranged adjacent a bottom shoulder of the openings O. The size and shape of the fuel cell FC can, of course, vary—as can the size, shape, position and number of the openings O. The membranes M can, of course, be of any type as long as they are pervious to hydrogen gas and impervious to liquids and solids, for example, of the type described herein. The fuel cell FC also includes a protective element PE. In the embodiment shown in FIG. 14, the protective element PE has the form of an enclosure made of a thin Teflon sheet material, e.g., of approximately 1 mm thick. The protective element PE includes walls (which may have the form of a generally rigid frame structure) which are arranged generally parallel to the fuel cell walls W. The sheet material forming the protective element PE also includes through openings for improving gas flow. The openings O are arranged in all areas of the sheet material except for areas which are directly adjacent the openings O and/or membranes M. The protective element PE can be spaced from walls W with foam pieces FP such that, e.g., dimension “a” is approximately 2 mm and dimension “b” is approximately 3 mm. To ensure that solid particles of the fuel are trapped and prevented from contacting the membranes M, the embodiment uses structures having the form of mesh baskets MB.

FIG. 15 illustrates one non-limiting arrangement of a membrane M with a coating C as described above. FIG. 16 illustrates one non-limiting arrangement of a fuel cell wall W with a coating C as described above.

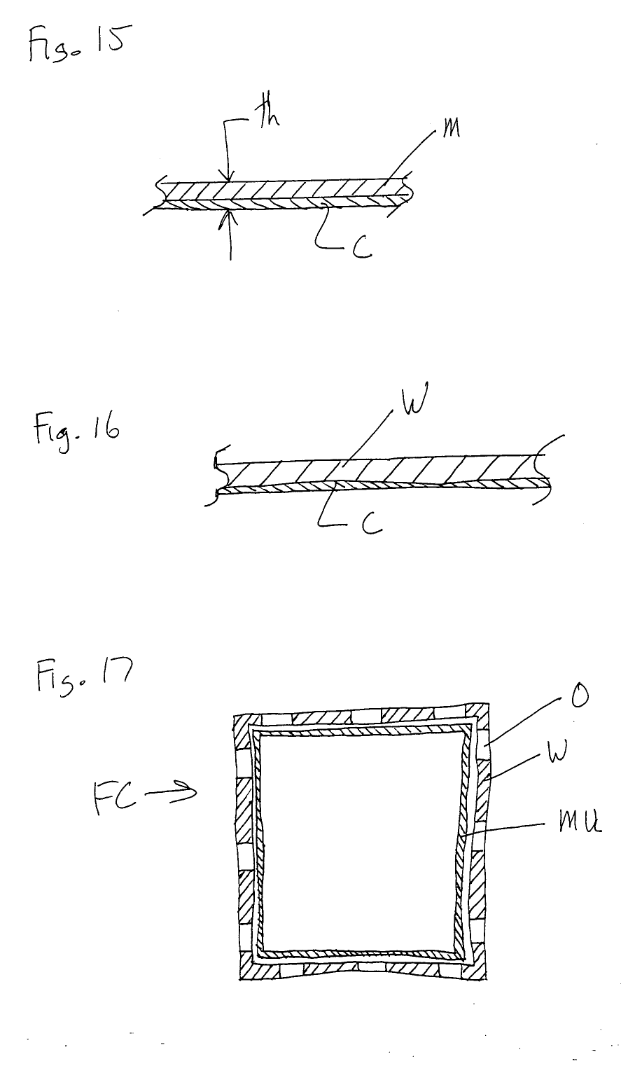

By way of another non-limiting example, FIG. 17 shows a fuel cell FC for use with a hydride-based fuel. The fuel cell FC is designed for being sealed in a liquid-tight manner when in operation. The fuel cell FC includes one or more openings, e.g., a plurality of openings O arranged in the walls W of the fuel cell FC. These openings O allow hydrogen gas formed inside the fuel cell FC to escape therefrom. A membrane unit MU (which may be removable from the fuel cell and which may have the form of, for example, a flexible bladder or rigid enclosure) is arranged within the walls W. The membrane unit MU is made of a material that is pervious to hydrogen gas and impervious to liquids and solids. The size and shape of the fuel cell FC can, of course, vary—as can the size, shape, position and number of the openings O. The membrane unit MU material can, of course, be of any type as long as it is pervious to hydrogen gas and impervious to liquids and solids, for example, of the type described herein. The fuel cell FC can also include a protective element PE of the type shown in, e.g., FIG. 12, if desired.

The invention also contemplates that the membrane M or membrane unit MU, or the material forming these, can have reinforcements and/or can otherwise be a reinforced membrane. By way of one non-limiting example, FIG. 18 shows a membrane M or membrane material reinforced by a mesh. The mesh includes first reinforcements R1 and second reinforcements R2. These reinforcements R1, R2 can be arranged in any desired pattern and can particularly be arranged in a crossing pattern with parallel reinforcements R1 and parallel reinforcements R2. In one aspect, the mesh may comprise a metallic material such as, e.g., nickel and/or stainless steel and/or the mesh may comprise an organic polymer such as, e.g., polytetrafluoroethylene, polypropylene, polyethylene and/or ABS (acrylonitrile-butadiene-styrene) copolymer.

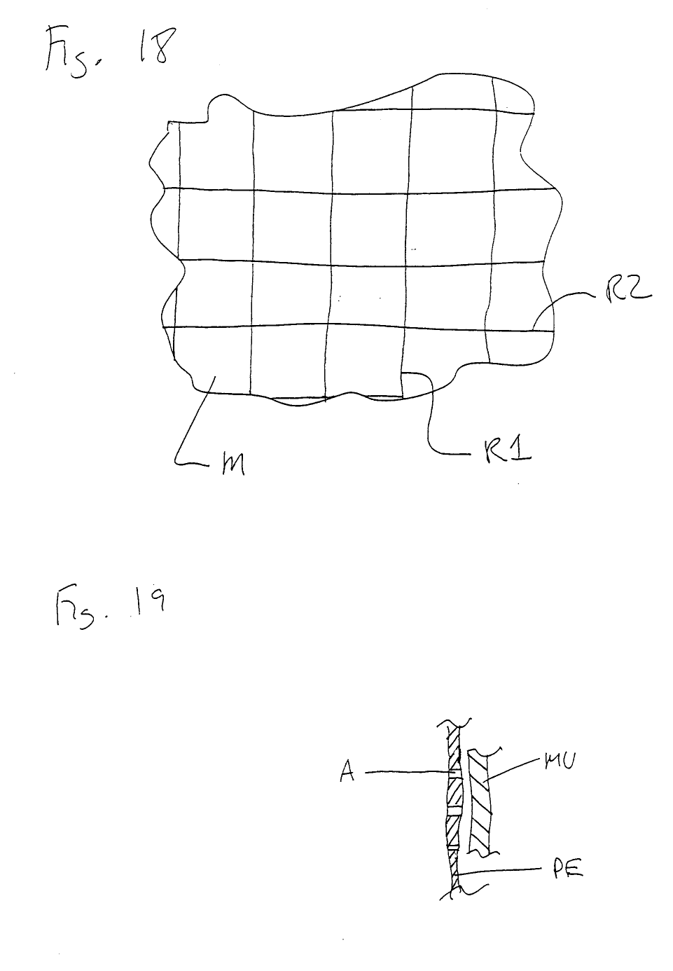

FIG. 19 shows one non-limiting example of a protective element PE arranged adjacent to a membrane M. The figure also illustrates one possible arrangement of apertures A in the protective element PE. The protective element PE and membrane M can be of any type described herein.

FIG. 20 illustrates one non-limiting example of a hydrogen sponge HS that can be placed into a fuel cell. The hydrogen sponge HS can have any desired shape and/or size and may be surrounded by a protective element PE which may also have any desired size and shape and which includes hydrogen-pervious and liquid- and solid-impervious apertures (e.g., pores). By way of non-limiting example, the hydrogen sponge may comprise one or more of metallic platinum, palladium, titanium, nickel, aluminum and/or alloys thereof. The material forming the hydrogen sponge HS may also have any form described herein.

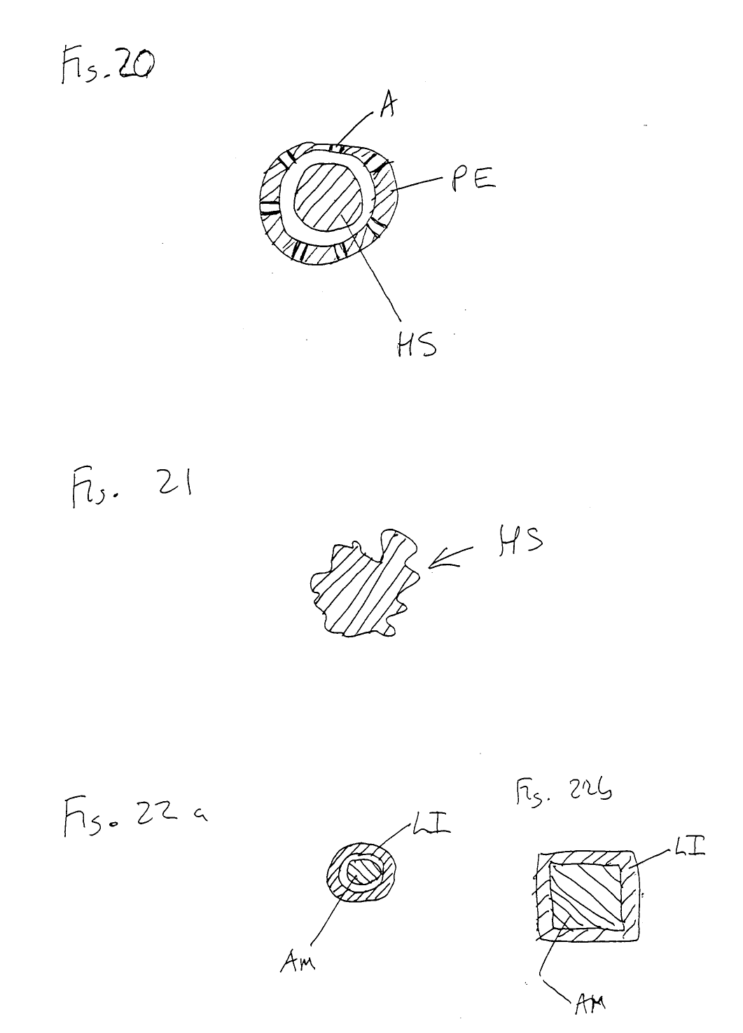

FIG. 21 illustrates one non-limiting example of a hydrogen sponge HS that can be placed into a fuel cell. The hydrogen sponge HS can have any desired irregular shape and/or size and may also have a coating of the type described herein. By way of non-limiting example, the hydrogen sponge may comprise one or more of metallic platinum, palladium, titanium, nickel, aluminum and/or alloys thereof.

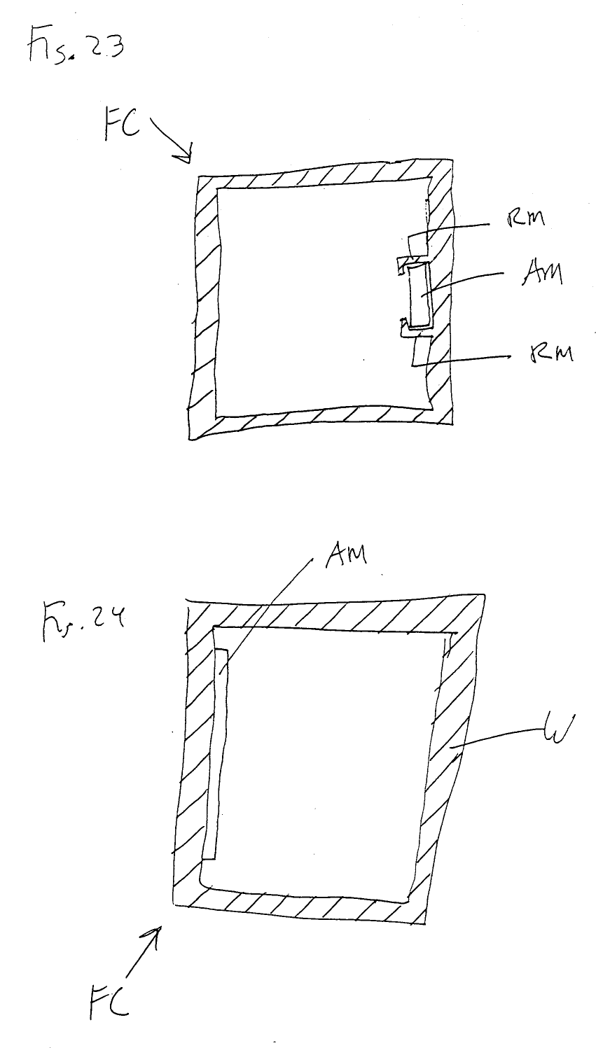

FIG. 22a illustrates one possible arrangement of a material AM which is capable of absorbing, adsorbing and/or undergoing a chemical reaction with molecular hydrogen and which can be placed in a fuel cell. The material AM may be enclosed by an inert material LI which is liquid-impervious and pervious to hydrogen. The inert material LI may also comprise a porous material. The device shown in FIG. 22a can be an element which is capable of being removed from the fuel cell and may have any desired shape and size.

FIG. 22b illustrates another possible arrangement of a material AM which is capable of absorbing, adsorbing and/or undergoing a chemical reaction with molecular hydrogen and which can be placed in a fuel cell. The material AM may be enclosed by a coating of inert material LI which is liquid-impervious and pervious to hydrogen. The inert material LI may also comprise a porous material. The device shown in FIG. 22b can also be an element which is capable of being removed from the fuel cell and may have any desired shape and size.

FIG. 23 illustrates one non-limiting way in which the material AM which is capable of absorbing, adsorbing and/or undergoing a chemical reaction with molecular hydrogen may be at least partially immobilized on one or more inner walls of the fuel cell. In this embodiment, one or more walls of the fuel cell include retaining members RM which act to contain and/or retain the material AM. Preferably, such retaining members RM allow for the easy removal of the material AM.

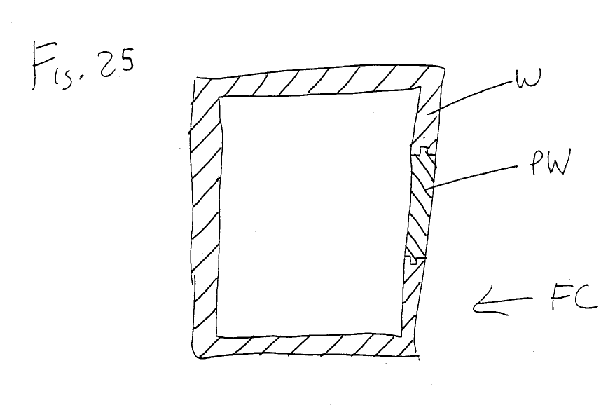

FIG. 24 illustrates another non-limiting way in which the material AM which is capable of absorbing, adsorbing and/or undergoing a chemical reaction with molecular hydrogen may be at least partially immobilized on one or more inner walls of the fuel cell. In this embodiment, the material AM is attached or otherwise secured to one or more walls of the fuel cell by, e.g. fasteners, adhesive bonding, etc.

The present invention also provides a fuel cell for use with a hydride-based fuel wherein at least a part of the fuel cell walls comprises a material which is pervious to hydrogen and impervious to liquids and solids. Such an example is illustrated in FIG. 25 wherein a material PW (which can be removably connected to permanently fixed to wall W) is arranged as part of one wall W forming the fuel cell FC.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A fuel cell for use with a hydride-based fuel, wherein the fuel cell is constructed and arranged to be sealed in a liquid-tight manner when in operation and wherein the fuel cell comprises at least one opening for allowing hydrogen gas formed inside the fuel cell to escape therefrom, which opening is sealed by a membrane that is pervious to hydrogen gas and impervious to liquids and solids.

2. The fuel cell of claim 1, wherein the membrane comprises a porous membrane which comprises a hydrophobic material.

3. The fuel cell of claim 2, wherein the membrane comprises pores having diameters of from about 0.1 μm to about 5 μm.

4. The fuel cell of claim 3, wherein the membrane has a thickness of from about 100 μm to about 300 μm.

5. The fuel cell of claim 2, wherein the hydrophobic material comprises a fluorine containing polymer.

6. The fuel cell of claim 5, wherein the fluorine containing polymer comprises a fluorine containing polyolefin.

7. The fuel cell of claim 4, wherein the hydrophobic material comprises polytetrafluoroethylene.

8. The fuel cell of claim 5, wherein the membrane further comprises activated carbon.

9. The fuel cell of claim 8, wherein the activated carbon is at least one of dispersed in and bonded by the fluorine containing polymer.

10. The fuel cell of claim 6, wherein the porous membrane comprises a hydrogen-pervious coating on at least a side thereof which faces an interior of the fuel cell, which coating has a surface energy which is lower than the surface energy of the porous membrane.

11. The fuel cell of claim 10, wherein the coating comprises a polymer with repeating units which comprise a fluorinated aliphatic group having at least about 5 fluorine atoms.

12. The fuel cell of claim 11, wherein the fluorinated aliphatic group comprises a fluoroalkyl group having from about 4 to about 20 carbon atoms.

13. The fuel cell of claim 12, wherein the fluorinated aliphatic group comprises a perfluoroalkyl group having from about 6 to about 10 carbon atoms.

14. The fuel cell of claim 11, wherein the fluorinated aliphatic group comprises a perfluorooctyl group.

15. The fuel cell of claim 7, wherein the polymer comprises units derived from perfluorooctyl methacrylate.

16. The fuel cell of claim 1, wherein the membrane is a porous membrane which comprises an inorganic material.

17. The fuel cell of claim 16, wherein the inorganic material comprises at least one of glass, ceramic, metal, alumina and zeolite.

18. The fuel cell of claim 17, wherein the membrane comprises pores having diameters of from about 0.1 μm to about 5 μm.

19. The fuel cell of claim 18, wherein the membrane has a thickness of from about 20 μm to about 1 mm.

20. The fuel cell of claim 18, wherein the membrane comprises a borosilicate material.

21. The fuel cell of claim 17, wherein the membrane comprises stainless steel.

22. The fuel cell of claim 16, wherein the membrane comprises a gas-pervious hydrophobic coating on at least a side thereof which faces an interior of the fuel cell.

23. The fuel cell of claim 22, wherein the coating comprises fluorinated aliphatic groups having at least about 5 fluorine atoms.

24. The fuel cell of claim 23, wherein the fluorinated aliphatic groups comprise fluoroalkyl groups having from about 4 to about 20 carbon atoms.

25. The fuel cell of claim 24, wherein the fluorinated aliphatic groups comprise perfluoroalkyl groups having from about 6 to about 10 carbon atoms.

26. The fuel cell of claim 23, wherein the fluorinated aliphatic groups comprise a perfluorooctyl group.

27. The fuel cell of claim 22, wherein the coating is derived from one or more hydrolyzable silanes which have at least one fluorinated aliphatic group directly bonded to a silicon atom, the fluorinated aliphatic group comprising from about 6 to about 10 carbon atoms and at least about 5 fluorine atoms.

28. The fuel cell of claim 27, wherein the one or more hydrolyzable silanes comprise at least one trialkoxyperfluoroalkylsilane.

29. The fuel cell of claim 28, wherein the at least one trialkoxyperfluoroalkylsilane comprises at least one of trimethoxyperfluorooctylsilane and triethoxyperfluorooctylsilane.

30. The fuel cell of claim 1, wherein the membrane is a non-porous membrane.

31. The fuel cell of claim 30, wherein the membrane comprises at least one of a silicone rubber and PTFE-treated activated carbon.

32. The fuel cell of claim 31, wherein the membrane comprises from about 90% to about 50% by weight of activated carbon and from about 50% to about 10% by weight of PTFE.

33. The fuel cell of claim 32, wherein the membrane has a thickness of from about 20 μm to about 1000 μm.

34. A membrane unit for a fuel cell which uses a hydride-based fuel, wherein the unit is impervious to liquid and solid components of a hydride-based fuel and comprises at least one membrane which is pervious to gas.

35. The membrane unit of claim 34, wherein the unit comprises at least one membrane which is impervious to liquid and pervious to hydrogen and, on at least one side of the at least one membrane, a protective element which protects the at least one membrane from at least one of a physical and a chemical attack by the fuel and its decomposition and reaction products.

36. The membrane unit of claim 35, wherein the protective element comprises a porous gas-pervious membrane which is more resistant to at least one of a physical and a chemical attack by the fuel and its decomposition and reaction products than the at least one membrane.

37. The membrane unit of claim 36, wherein the protective element comprises a porous membrane which comprises activated carbon.

38. The membrane unit of claim 37, wherein the porous membrane further comprises a fluorine containing polymer.

39. The membrane unit of claim 38, wherein the activated carbon is at least one of dispersed in and bonded by the fluorine containing polymer.

40. The membrane unit of claim 39, wherein the fluorine containing polymer comprises polytetrafluoroethylene.

41. The membrane unit of claim 35 wherein the protective element comprises a structure with sufficiently small openings to substantially prevent a physical attack of the at least one membrane by fuel-derived liquid and solid particles of high kinetic energy.

42. The membrane unit of claim 41 wherein the openings comprise holes having a diameter of not more than about 5 mm.

43. The membrane unit of claim 35, wherein the protective element comprises a structure with skewed slots.

44. The membrane unit of claim 32, wherein the protective element comprises a foam element which comprises pores having diameters which are large enough to allow liquid to pass through the foam element.

45. The membrane unit of claim 44, wherein the foam element comprises pores having diameters of from about 0.3 mm to about 5 mm.

46. The membrane unit of claim 44, wherein the foam element has a thickness of from about 1 mm to about 5 mm.

47. The membrane unit of claim 46, wherein the foam element comprises polytetrafluoroethylene.

48. The membrane unit of claim 35, wherein the protective element comprises at least one of polyurethane, polyethylene, polypropylene, polyvinyl chloride and ABS copolymer.

49. The membrane unit of claim 34, wherein the at least one membrane comprises a reinforced membrane.

50. The membrane unit of claim 49, wherein the reinforced membrane is reinforced by a mesh.

51. The membrane unit of claim 50, wherein the mesh comprises at least one of a metallic material and an organic polymer.

52. The membrane unit of claim 51, wherein the mesh comprises at least one of nickel and stainless steel.

53. The membrane unit of claim 51, wherein the mesh comprises at least one of polytetrafluoroethylene, polypropylene, polyethylene and ABS copolymer.

54. The membrane unit of claim 34, wherein the at least one membrane comprises a porous membrane.

55. The membrane unit of claim 54, wherein the porous membrane comprises a hydrophobic material.

56. The membrane unit of claim 55, wherein the hydrophobic material comprises a fluorine containing polyolefin.

57. The membrane unit of claim 56, wherein the hydrophobic material comprises polytetrafluoroethylene.

58. The membrane unit of claim 55, wherein the porous membrane comprises a gas-pervious coating on at least one side thereof, which coating has a surface energy which is lower than the surface energy of the porous membrane.

59. The membrane unit of claim 58, wherein the coating comprises a polymer with repeating units which have a perfluoroalkyl group with from about 6 to about 10 carbon atoms.

60. The membrane unit of claim 59, wherein the coating comprises poly(perfluorooctyl methacrylate).

61. The membrane unit of claim 54, wherein the porous membrane comprises an inorganic material.

62. The membrane unit of claim 61, wherein the inorganic material comprises at least one of glass, ceramic, metal, alumina and zeolite.

63. The membrane unit of claim 61, wherein the porous membrane comprises a gas-pervious hydrophobic coating on at least one side thereof.

64. The membrane unit of claim 63, wherein the coating comprises fluorinated aliphatic groups having from about 6 to about 10 carbon atoms.

65. The membrane unit of claim 64, wherein the fluorinated aliphatic groups comprise a perfluorooctyl group.

66. The membrane unit of claim 64, wherein the coating is derived from one or more hydrolyzable silanes which comprise at least one of trimethoxyperfluorooctylsilane and triethoxyperfluorooctylsilane.

67. The membrane unit of claim 34, wherein the at least one membrane comprises a non-porous membrane.

68. The membrane unit of claim 67, wherein the membrane comprises at least one of a silicone rubber and PTFE-treated activated carbon.

69. A fuel cell for use with a hydride-based fuel, wherein the fuel cell comprises the membrane unit of claim 34.

70. A fuel cell for use with a hydride-based fuel, wherein the fuel cell comprises at least one material which is capable of at least one of absorbing, adsorbing and undergoing a chemical reaction with molecular hydrogen.

71. The fuel cell of claim 70, wherein the material comprises a hydrogen sponge.

72. The fuel cell of claim 71, wherein the hydrogen sponge comprises at least one of metallic platinum, palladium, titanium, nickel, aluminum and alloys thereof.

73. The fuel cell of claim 70, wherein the material comprises a molecular sieve.

74. The fuel cell of claim 70, wherein the material comprises at least one of ceramics, zeolites, organic polymers and activated carbon.

75. The fuel cell of claim 70, wherein the material comprises a compound which is capable of being hydrogenated.

76. The fuel cell of claim 70, wherein the material comprises a compound having at least one unsaturated bond.

77. The fuel cell of claim 76, wherein the at least one unsaturated bond comprises at least one of a carbon-carbon double and a carbon-carbon triple bond.

78. The fuel cell of claim 76, wherein the material comprises at least one olefin having at least about 5 carbon atoms.

79. The fuel cell of claim 78, wherein the at least one olefin comprises a hexene.

80. The fuel cell of claim 75, wherein the material further comprises a hydrogenation catalyst.

81. The fuel cell of claim 70, wherein the material comprises a compound which is capable of oxidizing hydrogen.

82. The fuel cell of claim 81, wherein the compound comprises an oxygen-containing compound.

83. The fuel cell of claim 82, wherein the oxygen-containing compound comprises a salt.

84. The fuel cell of claim 83, wherein the salt comprises at least one of nitrogen and sulfur.

85. The fuel cell of claim 84, wherein the salt comprises a nitrate.

86. The fuel cell of claim 81, wherein the material further comprises an oxidation catalyst.

87. The fuel cell of claim 70, wherein the material is enclosed by an inert material which is liquid-impervious and pervious to hydrogen.

88. The fuel cell of claim 87, wherein the inert material comprises a porous material.

89. The fuel cell of claim 87, wherein the inert material forms a part of an element which is capable of being removed from the fuel cell.

90. The fuel cell of claim 70, wherein the material is at least partially immobilized on one or more inner walls of the fuel cell.

91. A fuel cell for use with a hydride-based fuel, wherein the fuel cell comprises at least one material which is capable of at least one of absorbing, adsorbing and undergoing a chemical reaction with gaseous hydrogen formed therein, and wherein the fuel cell further comprises at least one opening for allowing hydrogen gas formed inside the fuel cell to escape therefrom, which opening is sealed by a membrane that is pervious to hydrogen and impervious to liquids and solids.

92. A fuel cell for use with a hydride-based fuel, wherein the fuel cell comprises at least one membrane unit according to claim 34.

93. A fuel cell for use with a hydride-based fuel, wherein the fuel cell comprises fuel cell walls and wherein at least a part of the fuel cell walls comprises a material which is pervious to hydrogen and impervious to liquids and solids.

94. A fuel cell for use with a hydride-based fuel, wherein the fuel cell has corners and at least two of these corners each comprise one or more openings which are sealed by a material which is pervious to hydrogen and impervious to liquids and solids.

95. The fuel cell of claim 94, wherein all of the corners of the fuel cell comprise one or more openings which are sealed by a material which is pervious to hydrogen and impervious to liquids and solids.

96. A fuel cell for use with a liquid fuel, wherein the fuel cell comprises a fuel chamber and an electrolyte chamber and at least one of the fuel chamber and the electrolyte chamber enclose a volume which is shaped approximately like a “C” or an “I” with two approximately horizontal portions and one approximately vertical portion.

97. The fuel cell of claim 96, wherein the two approximately horizontal portions together enclose a volume which is not larger than about 10% of a total volume of the “C” or “I”.

98. The fuel cell of claim 96, wherein the two approximately horizontal portions together enclose a volume which is not smaller than about 1% of a total volume of the “C” or “I”.

99. The fuel cell of claim 96, wherein the fuel chamber encloses a volume which is shaped approximately like a “C” or an “I”.

100. The fuel cell of claim 96, wherein the electrolyte chamber encloses a volume which is shaped approximately like a “C” or an “I”.

101. The fuel cell of claim 96, wherein both the fuel chamber and the electrolyte chamber enclose a volume which is shaped approximately like a “C” or an “I”.

102. The fuel cell of claim 101, wherein each of the horizontal portions of the “C” and the “I” comprises at least one opening for allowing gas inside the fuel cell to escape therefrom, which opening is sealed by a membrane that is pervious to gas and impervious to liquids and solids.
